(19) United States
(12) Patent Application Publication
(10) Pub. No.: US 2026/0092152 A1
(43) Pub. Date: Apr. 2, 2026

(54) ETHYLENE-CARBOXYLIC ACID COPOLYMER DISPERSIONS, COMPOSITIONS THEREOF, AND RELATED METHODS

(71) Applicant: Michelman, Inc., Cincinnati, OH (US)

(72) Inventors: Max MOLLEO, Cincinnati, OH (US); Mark CLARK, Mason, OH (US)

(73) Assignee: Michelman, Inc., Cincinnati, OH (US)

(21) Appl. No.: 19/338,860

(22) Filed: Sep. 24, 2025

Related U.S. Application Data
(60) Provisional application No. 63/701,751, filed on Oct. 1, 2024.

(51) Int. Cl. C08J 3/05; C08F 8/44

(52) U.S. Cl. CPC C08J 3/05; C08F 8/44; C08F 2810/50; C08J 2323/08

(57) ABSTRACT

Aqueous dispersions may comprise a continuous phase comprising an aqueous-based carrier fluid, a coupling solvent, and a base; and particles dispersed in the continuous phase and comprising at least one ethylene-carboxylic acid (ECA) copolymer comprising a plurality of carboxylic acid (CA) groups, in which at least a portion of the CA groups are neutralized by at least a portion of the base. The at least one ECA copolymer has an acid value of about 70 milligrams of KOH per gram copolymer (mg KOH/g copolymer) to about 125 mg KOH/g copolymer. At least a majority of the coupling solvent comprises a glycol coupling solvent, a glycol ether coupling solvent, or any combination thereof.

### FIELD OF THE DISCLOSURE

The present disclosure relates generally to polymer dispersions and methods related thereto, and more particularly, the present disclosure relates to stable, high-solids dispersions of low melt flow index (MFI) and/or low-acid ethylene-carboxylic acid copolymers neutralized by reduced levels of one or more bases and methods related thereto.

### BACKGROUND

Aqueous dispersions of ethylene-carboxylic acid (ECA) copolymers and salts thereof are preferred in many applications over the other forms of these materials, as aqueous dispersions provide several advantages. Advantages include, for example, low process requirements, as dispersions do not require the use of heavy and expensive processing equipment, such as extruders, for example; ability to form coatings having a film thickness of only a few micrometers instead of a minimum thickness of several tens of micrometers obtained when using polymer emulsions or polymer melts; and environmental benefits due to the water-based nature of the dispersions. The dispersions may be suitably applied by many different coating processes including immersion coating, spray coating, and processes using a coater device, such as an air knife, blade, gravure roll or metering rod coater, depending on the substrate and the effects desired.

Among the coating applications where ECA copolymer aqueous dispersions may be used include, for example, coatings or adhesives on foil, metal, paper, polymer, or textiles. ECA copolymers also demonstrate crosslinking capability and excellent adhesion for modifiers or additives in paints or inks; binders for non-wovens; rustproof aqueous coatings, and antistatic coating materials, for example.

Dispersibility of ECA copolymers may be affected by one or more of the following factors: (1) the type and amount of base used to neutralize the carboxylic acid monomers, (2) the type and amount of acid monomer(s) present in the ECA copolymer, and (3) the process conditions during dispersion production. Bases which may be vaporized (volatile bases) after deposition of the ECA dispersion, such as ammonia and amines, are generally preferred in applications where the presence of metals is not desirable and high water resistance is needed. The ECA copolymers that are typically easiest to disperse are those having a high melt flow index (MFI) and a high acid content. A high MFI (or correspondingly low molecular weight) provides for easier solubility of the copolymer, while a high acid content provides for higher hydrophilicity of the copolymer, both of which may promote better dispersibility in an aqueous phase. Typical commercial ECA copolymers that are dispersible have MFI values higher than about 300 grams per 10 minutes (g/10 min) and an acid content of about 20 weight percent (wt %) or greater. As the MFI and/or the acid content decrease, the copolymer typically becomes more difficult to disperse.

Dispersions containing ECA copolymers having low MFI and/or low-acid content are more difficult to prepare using single bases, such as NaOH, KOH or NH₄OH alone. Although mixed bases may facilitate dispersion, mixed bases may be undesirable in many dispersion applications due to the presence of metals and/or the decreased water resistance that results. Further, dispersions using mixed bases for low MFI and/or low-acid content ECA copolymers are more difficult to prepare when less than about 50 molar percent (mol %) of carboxylic acids repeat units in the copolymers are neutralized with a base.

### SUMMARY

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to various embodiments consistent with the present disclosure, ethylene-carboxylic acid dispersions are provided. The ethylene-carboxylic acid dispersions comprise: a continuous phase comprising an aqueous-based carrier fluid, a coupling solvent, and a base; and particles dispersed in the continuous phase and comprising at least one ethylene-carboxylic acid (ECA) copolymer comprising a plurality of carboxylic acid (CA) groups, and at least a portion of the CA groups are neutralized by at least a portion of the base. The at least one ECA copolymer has an acid value of about 70 milligrams of KOH per gram copolymer (mg KOH/g copolymer) to about 125 mg KOH/g copolymer. At least a majority of the coupling solvent comprises a glycol coupling solvent, a glycol ether coupling solvent, or any combination thereof.

According to various embodiments consistent with the present disclosure, methods for making ethylene-carboxylic acid dispersions are provided. The methods comprise: forming a mixture comprising: a continuous phase comprising an aqueous-based carrier fluid, a coupling solvent, and a base; and at least one ethylene-carboxylic acid (ECA) copolymer comprising a plurality of carboxylic acid (CA) groups, and at least a portion of the CA groups are neutralized by at least a portion of the base; wherein the at least one ECA copolymer has an acid value of about 70 milligrams of KOH per gram copolymer (mg KOH/g copolymer) to about 125 mg KOH/g copolymer, and at least a majority of the coupling solvent comprises a glycol coupling solvent, a glycol ether coupling solvent, or any combination thereof; heating the mixture at an operation temperature of at least the melting point of the at least one ECA copolymer to form an aqueous emulsion comprising liquid droplets of the at least one ECA copolymer; and cooling the aqueous emulsion to or below a temperature at which solid particles of the ECA copolymer form and produce an aqueous dispersion comprising the solid particles dispersed in the continuous phase.

Any combinations of the various embodiments and implementations disclosed herein may be used in a further embodiment, consistent with the disclosure. These and other aspects and features may be appreciated from the following description of certain embodiments presented herein in accordance with the disclosure and claims.

### BRIEF DESCRIPTION OF THE DRAWINGS

Not applicable.

### DETAILED DESCRIPTION

The present disclosure relates generally to polymer dispersions and methods related thereto, and more particularly, the present disclosure relates to stable, high-solids dispersions of low melt flow index (MFI) and/or low-acid ethylene-carboxylic acid (ECA) copolymers neutralized by reduced levels of one or more bases and methods related thereto.

ECA copolymers having a low MFI and/or a low-acid content may be desirable in comparison to ECA copolymers that are more casily dispersible in aqueous fluids. A low MFI may promote properties such as improved scratch and abrasion resistance, and hot tack (e.g., scal strength), and a low-acid content may promote better adhesion to polymer substrates such as low-density polyethylene (LDPE). Both properties may provide better chemical resistance to the coating as well. However, producing stable, high-solids aqueous dispersions of ECA copolymers having a low MFI and/or a low-acid content is one of the main challenges in the use of such materials in various applications. The present disclosure addresses these needs and provides related advantages as well.

Embodiments in accordance with the present disclosure generally relate to aqueous dispersions of ECA copolymers, compositions thereof, and related methods. The aqueous dispersions of ECA copolymers of the present disclosure provide environmentally favorable, customized high-performance systems that may be used in water-borne coatings, e.g., as adhesion promoters for metal substrates. The aqueous dispersions may improve a water-borne coating's barrier properties while reducing an overall level of volatile organic compounds (VOCs) and extent of additive leaching (e.g., surfactants). The aqueous dispersions may further reduce or eliminate materials which are a cause for concern for food contact, such as metals, surfactants, and dispersants, while reducing pH levels, which in turn reduces corrosion concerns for metal substrates.

In various aspects, the present disclosure provides methods for forming aqueous dispersions of ethylene-carboxylic acid (ECA) copolymers comprising a plurality of carboxylic acid (CA) groups, which may be partially or completely neutralized. In the present disclosure, a suitable coupling solvent may be utilized to promote formation of the dispersion of the ECA copolymers. The coupling solvent may be particularly advantageous when dispersing ECA copolymers having a lower MFI and/or a low-acid content, as discussed further herein. Aqueous dispersions of ECA copolymers may be formed by dispersing ECA copolymers in a continuous phase comprising an aqueous-based carrier fluid, e.g., water, and the coupling solvent under appropriate conditions. Advantageously, at least a majority of the coupling solvent comprises a glycol coupling solvent, a glycol ether coupling solvent, or any combination thereof. Such dispersions may be produced in an environmentally friendly manner by mixing ECA copolymer solids comprising a plurality of carboxylic acid groups in the continuous phase with a base under agitation and at temperatures above the melting point of the ECA copolymers. During dispersion formation, the base may react with at least a portion of the carboxylic acid groups in the ECA copolymers to promote deprotonation and to form the corresponding carboxylic acid salt comprising the cation portion of the base, thus at least partially neutralizing the ECA copolymers. This reaction induces high polarity to the ethylene-carboxylic acid copolymer and may stabilize the dispersion. In various embodiments, no surfactants or other additives are required to promote dispersion of the ECA copolymers.

In various aspects, the present disclosure provides aqueous dispersions of ECA copolymers. Aqueous dispersions of the present disclosure may comprise: a continuous phase comprising: an aqueous-based carrier fluid, a coupling solvent, and a base; and particles dispersed in the continuous phase, wherein the particles comprise at least one ethylene-carboxylic acid (ECA) copolymer comprising a plurality of carboxylic acid (CA) groups, wherein at least a portion of or all of the CA groups are present in the form of a neutralized salt thereof. The base is capable of neutralizing an un-neutralized CA group to form a neutralized salt thereof, wherein the base is dissolved in the continuous phase. At least a majority of the coupling solvent comprises a glycol coupling solvent, a glycol ether coupling solvent, or any combination thereof. Further description of suitable ECA copolymers and other components of the aqueous dispersions is provided hereinafter. In various aspects, aqueous dispersions of ECA copolymers of the present disclosure are prepared by the methods described herein.

The aqueous dispersions may comprise at least one ECA copolymer. In some embodiments, one ECA copolymer may be dispersed in the aqueous phase. In other embodiments, two or more ECA copolymers may be dispersed in the aqueous phase. Single or multiple ECA copolymers may each be a low acid ECA copolymer, as defined further herein. A coupling solvent may advantageously facilitate co-dispersion of multiple ECA copolymers, which may otherwise be difficult.

Various types of ethylene-carboxylic acid (ECA) copolymers may be used to prepare the aqueous dispersions described herein. As used herein, the term “ethylene-carboxylic acid (ECA) copolymer,” and grammatical variations thereof, generally refer to copolymers of an ethylene monomer with one or more C₃ to C₈ α,β-ethylenically unsaturated carboxylic acid (CA) comonomers (aka, CA repeat units). Thus, ECA copolymers comprise a plurality of ethylene repeat units and CA repeat units, typically as a random copolymer. ECA copolymers of the present disclosure may comprise various types of CA repeat units. CA repeat units may comprise a single CA group or two or more CA groups. Suitable examples of CA repeat units may include acrylic acid, methacrylic acid, itaconic acid, crotonic acid (trans-butenoic acid), isocrotonic acid (cis-butenoic acid), vinylacetic acid, (E)-4-methoxy-4-oxo-but-2-enoic acid, (Z)-4-ethoxy-4-oxo-but-2-enoic acid, vinyl lactic acid, maleic acid, 2-methylmaleic acid, aconitic acid, the like, and any combination thereof. In preferred embodiments, the CA repeat units may comprise acrylic acid, methacrylic acid, or a combination of acrylic acid (AA) and methacrylic acid (MAA) repeat units. In various embodiments, the CA repeat units may consist of either AA or MAA repeat units. Thus, ECA copolymers may comprise ethylene-acrylic acid (EAA) or ethylene-methacrylic acid (EMAA) in some examples. In particularly suitable examples, the ECA copolymer may comprise or consist of ethylene-acrylic acid (EAA).

ECA copolymers of the present disclosure may comprise various amounts of CA repeat units, each comprising one or more CA groups. The amount of CA groups (i.e., acid equivalents) in an ECA copolymer may be measured by titration with a base to an equivalence point (e.g., visual, potentiometric, or the like) (e.g., as determined by ASTM D4094), Fourier Transform Infrared (FTIR) spectroscopy, nuclear magnetic resonance (NMR) spectroscopy, or the like. ECA copolymers of the present disclosure may have various acid values. For example, ECA copolymers suitable for use herein may have an acid value of about 125 mg KOH/gram (mg KOH/g) of ECA copolymer or less, including all values and subranges in between, such as about 120 mg KOH/g or less, or about 110 mg KOH/g or less, or about 100 mg KOH/g or less, or about 90 mg KOH/g or less, or about 80 mg KOH/g or less, or about 70 mg KOH/g or less, or about 60 mg KOH/g or less, or about 50 mg KOH/g or less.

ECA copolymers suitable for use herein may have an acid value of about 50 mg KOH/g to about 125 mg KOH/gram (mg KOH/g) of ECA copolymer, including all values and subranges in between, such as about 60 mg KOH/g to about 125 mg KOH/g, or about 70 mg KOH/g to about 125 mg KOH/g, or about 70 mg KOH/g to about 117 mg KOH/g, or about 80 mg KOH/g to about 125 mg KOH/g, or about 80 mg KOH/g to about 117 mg KOH/g, or about 90 mg KOH/g to about 125 mg KOH/g, or about 90 mg KOH/g to about 120 mg KOH/g, or about 90 mg KOH/g to about 117 mg KOH/g, or about 50 mg KOH/g to about 120 mg KOH/g resin, or about 60 mg KOH/g to about 120 mg KOH/g, or about 70 mg KOH/g to about 120 mg KOH/g, or about 80 mg KOH/g to about 120 mg KOH/g, or about 90 mg KOH/g to about 120 mg KOH/g, or about 100 mg KOH/g to about 120 mg KOH/g, or about 110 mg KOH/g to about 120 mg KOH/g, or about 50 mg KOH/g to about 110 mg KOH/g resin, or about 60 mg KOH/g to about 110 mg KOH/g, or about 70 mg KOH/g to about 110 mg KOH/g, or about 80 mg KOH/g to about 110 mg KOH/g, or about 90 mg KOH/g to about 110 mg KOH/g, or about 100 mg KOH/g to about 110 mg KOH/g, or about 50 mg KOH/g to about 100 mg KOH/g resin, or about 60 mg KOH/g to about 100 mg KOH/g, or about 70 mg KOH/g to about 100 mg KOH/g, or about 80 mg KOH/g to about 100 mg KOH/g, or about 90 mg KOH/g to about 100 mg KOH/g, or about 50 mg KOH/g to about 90 mg KOH/g resin, or about 60 mg KOH/g to about 90 mg KOH/g, or about 70 mg KOH/g to about 90 mg KOH/g, or about 80 mg KOH/g to about 90 mg KOH/g, or about 50 mg KOH/g to about 80 mg KOH/g resin, or about 60 mg KOH/g to about 80 mg KOH/g, or about 70 mg KOH/g to about 80 mg KOH/g, or about 50 mg KOH/g to about 70 mg KOH/g resin, or about 60 mg KOH/g to about 70 mg KOH/g, or about 50 mg KOH/g to about 60 mg KOH/g.

An EAA copolymer containing about 16 wt % AA repeat units may have an acid value of about 125 mg KOH/g, an EAA copolymer containing about 15 wt % AA repeat units may have an acid value of about 117 mg KOH/g, an EAA copolymer containing about 11 wt % AA repeat units may have an acid value of about 86 mg KOH/g, an EAA copolymer containing about 9.5 wt % AA repeat units may have an acid value of about 74 mg KOH/g, and an EAA copolymer containing about 8 wt % AA repeat units may have an acid value of about 62 mg KOH/g. An EMAA copolymer containing about 19 wt % MAA repeat units may have an acid value of about 125 mg KOH/g, an EMAA copolymer containing about 15 wt % MAA repeat units may have an acid value of about 98 mg KOH/g, an EMAA copolymer containing about 11 wt % MAA repeat units may have an acid value of about 72 mg KOH/g, and an EMAA copolymer containing about 8 wt % MAA repeat units may have an acid value of about 52 mg KOH/g. Any of the foregoing may be used as the ECA copolymer in the disclosure herein. Thus, in some examples, the ECA copolymer may have an acid value of about 70 mg KOH/g copolymer to about 117 mg KOH/g copolymer.

ECA copolymers of the present disclosure may have various melt flow index (MFI) values as measured at 190° C. under a load of 2.16 kg in accordance with ASTM D1238. ECA copolymers suitable for use herein may have MFI values, according to ASTM D1238 of about 500 g/10 min or less, including all values and subranges in between, such as about 450 g/10 min or less, or about 400 g/10 min or less, or about 350 g/10 min or less, or about 300 g/10 min or less, or about 250 g/10 min or less, or about 200 g/10 min or less, or about 150 g/10 min or less, or about 100 g/10 min or less, or about 90 g/10 min or less, or about 80 g/10 min or less, or about 70 g/10 min or less, or about 60 g/10 min or less, or about 50 g/10 min or less, or about 40 g/10 min or less, or about 30 g/10 min or less, or about 20 g/10 min or less, or about 10 g/10 min or less. ECA copolymers suitable for use herein may have MFI values, according to ASTM D1238 of about 1 g/10 min to about 500 g/10 min, including all values and subranges in between, such as about 1 g/10 min to about 450 g/10 min, or about 2 g/10 min to about 400 g/10 min, or about 3 g/10 min to about 300 g/10 min, or about 4 g/10 min to about 200 g/10 min, or about 5 g/10 min to about 100 g/10 min, or about 5 g/10 min to about 70 g/10 min, or about 6 g/10 min to about 80 g/10 min, or about 7 g/10 min to about 70 g/10 min, or about 8 g/10 min to about 60 g/10 min.

When the CA repeat units include MAA repeat units, the ECA copolymers may have MFI values of about 300 g/10 min or less, such as about 250 g/10 min or less, or about 200 g/10 min or less, or about 150 g/10 min or less, or about 100 g/10 min or less, or about 90 g/10 min or less, or about 80 g/10 min or less, or about 70 g/10 min or less, or about 60 g/10 min or less, or about 50 g/10 min or less, or about 40 g/10 min or less, or about 30 g/10 min or less, or about 20 g/10 min or less, or about 10 g/10 min or less, or about 5 g/10 min or less, or about 1 g/10 min or less, such as about 1 g/10 min to about 500 g/10 min, or about 1 g/10 min to about 400 g/10 min, or about 1 g/10 min to about 300 g/10 min, or about 1 g/10 min to about 200 g/10 min, or about 1 g/10 min to about 100 g/10 min, or about 1 g/10 min to about 90 g/10 min, or about 1 g/10 min to about 80 g/10 min, or about 1 g/10 min to about 70 g/10 min, or about 1 g/10 min to about 60 g/10 min, or about 5 g/10 min to about 70 g/10 min, or about 10 g/10 min to about 90 g/10 min, or about 20 g/10 min to about 80 g/10 min, or about 30 g/10 min to about 70 g/10 min, or about 40 g/10 min to about 60 g/10 min. When the CA repeat units include AA repeat units, the ECA copolymers may have MFI values of about 100 g/10 min or less, such as about 90 g/10 min or less, or about 80 g/10 min or less, or about 70 g/10 min or less, or about 60 g/10 min or less, or about 50 g/10 min or less, or about 40 g/10 min or less, or about 30 g/10 min or less, or about 20 g/10 min or less, or about 10 g/10 min or less, or about 5 g/10 min or less, or about 1 g/10 min or less, such as about 1 g/10 min to about 100 g/10 min, or about 1 g/10 min to about 90 g/10 min, or about 1 g/10 min to about 80 g/10 min, or about 1 g/10 min to about 70 g/10 min, or about 1 g/10 min to about 60 g/10 min, or about 5 g/10 min to about 70 g/10 min, or about 10 g/10 min to about 90 g/10 min, or about 20 g/10 min to about 80 g/10 min, or about 30 g/10 min to about 70 g/10 min, or about 40 g/10 min to about 60 g/10 min.

Examples of suitable ECA copolymers that may be used in the present disclosure include, for example, PRIMACOR™ series resins (Dow Chemical, e.g., PRIMACOR™ 4810, 3004, 3440, and 3460), ESCOR™ series resins (ExxonMobil, e.g., Escor™ 5100, and 5200), and NUCREL™ series resins (Dow Chemical, e.g., NUCREL™ 599, 699, 925, and 960).

Methods of the present disclosure may use various bases to neutralize CA groups of ECA copolymers, thereby forming salts thereof. Bases used to neutralize CA groups of ECA copolymers may be divided into two major categories. The first includes metal-containing bases, such as those based on alkali metal cations and alkaline earth metal cations. Examples of these include, for example, sodium hydroxide (NaOH), potassium hydroxide (KOH), lithium hydroxide, rubidium hydroxide, cesium hydroxide, calcium hydroxide, strontium hydroxide, barium hydroxide, sodium carbonate (Na₂CO₃), potassium carbonate (K₂CO₃), sodium bicarbonate (NaHCO₃), potassium bicarbonate (KHCO₃), or zinc oxide (ZnO), just to name a few. The second category includes volatile bases including ammonia gas (NH₃) and/or aqueous ammonia (i.e., ammonium hydroxide (NH₄OH)) and/or volatile amines. Metal-containing bases provide the dispersion with high performance properties typical of ionomeric copolymers, which may include high crosslinking, high chemical resistance, and good mechanical properties. Bases belonging in the second category may be vaporized after dispersion application and therefore are more preferred in applications where the presence of metals is not desirable, and for conveying higher water resistance following solvent removal from the dispersion.

In various embodiments, the base may comprise or consist of at least one volatile base. In various embodiments, the volatile base consists of one volatile base or a mixture of two or more different volatile bases. As used herein, the term “volatile,” and grammatical variations thereof, generally refer to the ability to evaporate from an aqueous phase upon drying. In various embodiments, the aqueous dispersions may exclude a metal-containing base. As used herein, the term “metal-containing,” and grammatical variations thereof, generally refer to compounds comprising alkali metal and/or alkaline earth metals (e.g., oxides, hydroxides, and/or carbonates thereof).

Volatile bases suitable for use in the present disclosure may include ammonia and/or amines. Suitable amines may include, for example, alkyl amines, alkanolamines, the like, and any combination thereof. Suitable examples of alkyl amines may include, but are not limited to hydrazine, methylamine, ethylamine, diethylamine, triethylamine, isobutylamine, N,N-diisopropylethylamine, morpholine, piperazinc, ethylenediamine, 1,4-diazabicyclo[2.2.2]octane, the like, and any combination thereof. Suitable examples of alkanolamines may include, but are not limited to, monocthanolaminc (MEA), dicthanolamine (DEA), tricthanolamine (TEA), aminomethylpropanol (AMP), dimethylaminomethylpropanol (DMAMP), dimethylaminocthanol (DMAE), diethylaminocthanol (DEAE), dimethylaminopropanol (DMAP), the like, and any combination thereof. In various embodiments, the volatile base may consist of a single volatile base. The volatile base may consist of ammonia. The volatile base may consist of a single amine, such as an alkyl amine or an alkanolamine. The volatile base may comprise two or more different volatile bases. The volatile base may consist of two or more different amines, such as two or more different alkyl amines, alkanolamines, or any mixture thereof. In various embodiments, the volatile base may consist of one or more alkanolamines.

Methods of the present disclosure may use suitable amounts of a base to achieve variable amounts of neutralization prior to and/or after preparing aqueous dispersions thereof. The degree of neutralization may at least partially determine the polarity of the ECA copolymer, with higher neutralization levels favoring better dispersibility. However, with increasing neutralization comes a decreased particle size and a correspondingly increased viscosity of the dispersion at higher neutralization levels. Lower neutralization levels may provide for dispersions having a higher solids content as well as retaining a portion of carboxylic acid groups intact (protonated), but without an undesired viscosity increase, which may be desirable for many applications. Within the aqueous dispersions described herein, the ECA copolymers may have a degree of neutralization of about 10 acid equivalent percent (eq %) to about 100 acid eq %, based on the total number of CA groups in the ECA copolymer, including all acid eq % values and subranges in between, such as 10 acid eq % to 90 acid eq %, 20 acid eq % to 100 acid eq %, 30 acid eq % to 100 acid eq %, 30 acid eq % to 90 acid eq %, 30 acid eq % to 80 eq %, 30 acid eq % to 70 acid eq %, 30 acid eq % to 60 acid eq %, 30 acid eq % to 50 acid eq %, 30 acid eq % to 40 acid eq %, 40 acid eq % to 100 acid eq %, 40 acid eq % to 90 acid eq %, 40 acid eq % to 80 eq %, 40 acid eq % to 70 acid eq %, 40 acid eq % to 60 acid eq %, 40 acid eq % to 50 acid eq %, 50 acid eq % to 100 acid eq %, 50 acid eq % to 90 acid eq %, 50 acid eq % to 80 eq %, 50 acid eq % to 70 acid eq %, 50 acid eq % to 60 acid eq %, 60 acid eq % to 100 acid eq %, 60 acid eq % to 90 acid eq %, 60 acid eq % to 80 eq %, 60 acid eq % to 70 acid eq %, 70 acid eq % to 100 acid eq %, 70 acid eq % to 90 acid eq %, 70 acid eq % to 80 acid eq %, 80 acid eq % to 100 acid eq %, 80 acid eq % to 90 eq %, or 90 acid eq % to 100 acid eq %.

Aqueous dispersions of the present disclosure may include various bases dissolved in the aqueous-based carrier fluid of the continuous phase. As used herein, the term “base” refers to a compound comprising at least one functional group capable of reacting with hydrogen ions (H+) in an acid-base reaction. As used herein, one equivalent of a base is the amount of base which will react in an acid-base reaction with one mole of hydrogen ions. For example, a base comprising a single hydrogen ion-accepting group per molecule (e.g., ammonia) comprises 1 equivalent of the base per molecule and may neutralize one CA group, while a base comprising two hydrogen ion-accepting groups per molecule (e.g., an amine with two —NH₂ groups) includes 2 equivalents of the base per molecule and may neutralize two CA groups. Similarly, one mole of carboxylic acid (CO₂H) groups comprises one mole of hydrogen ions (H⁺), and thus a CA repeat unit comprising a single carboxylic acid (CO₂H) group has 1 mole of acid groups per mole of CA repeat units.

Aqueous dispersions of the present disclosure may utilize ECA copolymers having various degrees of neutralization of the CA groups, while methods of the present disclosure may neutralize ECA copolymers, prior to and/or after preparing said aqueous dispersions, to said degrees of neutralization of the CA groups, as measured by titration of aqueous dispersions of the ECA copolymers with sodium hydroxide or the like. Methods of preparing aqueous dispersions of ECA copolymers may utilize using one or more bases capable of providing a particular degree of neutralization of the CA groups. The CA groups may be partially or fully neutralized depending on the amount of base added to the aqueous dispersions of the ECA copolymers. The degree of neutralization of the CA groups may be selected to provide a desired particle size of the ECA copolymers in the aqueous dispersions.

Methods of the present disclosure for preparing aqueous dispersions of ECA copolymers may comprise adding a base to the mixture of the aqueous-based carrier fluid, the coupling solvent, and the ECA copolymers, where the base is present therein at about 10 base eq % to about 150 base eq % or at about 30 base eq % to about 150 base eq %, based on the total number of acid equivalents (e.g., CO₂H equivalents) in the ECA copolymers, including all % values and subranges in between, such as about 30 base eq % to about 140 base eq %, or about 35 base eq % to about 135 base eq %, or about 40 base eq % to about 130 base eq %, or about 45 base eq % to about 125 base eq %, or about 50 base eq % to about 120 base eq %, or about 55 base eq % to about 115 base eq %, or about 60 base eq % to about 110 base eq %, or about 65 base eq % to about 105 base eq %, or about 70 base eq % to about 100 base eq %, or about 75 base eq % to about 95 base eq %, or about 80 base eq % to about 100 base eq %, or about 85 base eq % to about 105 base eq %, or about 90 base eq % to about 110 base eq %, or about 30 base eq % to about 50 base eq %, or about 35 base eq % to about 55 base eq %, or about 40 base eq % to about 60 base eq %, or about 45 base eq % to about 65 base eq %, or about 50 base eq % to about 70 base eq %, or about 55 base eq % to about 75 base eq %, or about 60 base eq % to about 80 base eq %, or about 65 base eq % to about 85 base eq %, or about 70 base eq % to about 90 base eq %, or about 75 base eq % to about 100 base eq %, or about 30 base eq % to about 40 base eq %, or about 40 base eq % to about 50 base eq %, or about 50 base eq % to about 60 base eq %, or about 60 base eq % to about 70 base eq %, or about 70 base eq % to about 80 base eq %, or about 80 base eq % to about 90 base eq %, or about 90 base eq % to about 100 base eq %, or about 100 base eq % to about 110 base eq %, or about 110 base eq % to about 120 base eq %, or about 120 base eq % to about 130 base eq %, or about 130 base eq % to about 140 base eq %. The number of base equivalents may be selected to achieve a target degree of neutralization of the CA groups and a target pH range. In some instances, more than a stoichiometric quantity of base equivalents may be utilized to neutralize a given number of acid equivalents.

Methods of the present disclosure for preparing aqueous dispersions of ECA copolymers having an acid value of 110 mg KOH/g to 120 mg KOH/g may comprise adding a base at about 10 base eq % to about 50 base eq %, or about 30 base eq % to about 50 base eq %, based on the total number of acid equivalents (e.g., CO₂H equivalents) in the ECA copolymers, including all base eq % values and subranges in between, such as about 30 base eq % to about 40 base eq %, or about 40 base eq % to about 50 base eq %. Methods for preparing aqueous dispersions of ECA copolymers having an acid value of 80 mg KOH/g to 110 mg KOH/g may comprise adding a base at about 80 base eq % to about 120 base eq %, based on the total number of acid equivalents (e.g., —CO₂H equivalents) in the ECA copolymers, including all base eq % values and subranges in between, such as about 80 base eq % to about 100 base eq %, or about 90 base eq % to about 110 base eq %, or about 100 base eq % to about 120 base eq %.

The present disclosure may utilize various sources of aqueous-based carrier fluids to prepare aqueous dispersions of ECA copolymers. The aqueous-based carrier fluid may be any suitable fluid, such as water or a solution containing both water and one or more organic or inorganic compounds dissolved in the water or otherwise completely miscible with the water. Examples of water sources may include, but are not limited to, freshwater, well water, filtered water, distilled water, soft water, hard water, seawater, salt water, the like, and any combination thereof.

The present disclosure may use various types of coupling solvents in forming aqueous dispersions of ECA copolymers. As used herein, the term “coupling solvent,” generally refers to a solvent which has a measurable coupling ability of mineral spirits and water. As used herein, a “coupling ability”, and grammatical variations thereof, refer generally to an ability to impart mutual solubility, e.g., as evidenced by a lack of visual turbidity, to equal volumes of mineral spirits (e.g., Kauri-butanol value of 29) and water. (Hansen, “Solvents in Water-Borne Coatings,” Ind. Eng. Chem., Prod. Res. Dev., Vol. 6, No. 3, 1977). The more powerful the coupling ability, the smaller the volume fraction of the coupling solvent required to impart mutual solubility. Similarly, at lower acid contents and/or lower degrees of neutralization, a greater amount of coupling solvent may be needed. In various embodiments, a coupling solvent has an ability to impart mutual solubility between mineral spirits and water at a volume fraction of about 92 vol % or less, including all values and subranges in between, such as about 90 vol % or less, or about 85 vol % or less, or about 80 vol % or less, or about 75 vol % or less, or about 70 vol % or less, or about 65 vol % or less, or about 60 vol % or less, or about 55 vol % or less.

Alternately, the term “coupling solvent,” may refer to a solvent which is a “boundary solvent” between mineral spirits and water, as shown by an intermediate location between mineral spirits and water on a Hansen solubility parameter diagram (e.g., δ_{P} (cal/cm³)^{1/2} vs. δ_{H} (cal/cm³)^{1/2}, where op is the energy from dipolar intermolecular forces between molecules, and δ_{H} is the energy from hydrogen bonds between molecules. In various embodiments, a “boundary solvent” displays the following location between mineral spirits and water on a Hansen solubility parameter diagram: a &p value of about 2 (cal/cm³)^{1/2} to about 5 (cal/cm³)^{1/2} vs. a δ_{H} value of about 4 (cal/cm³)^{1/2} to about 8 (cal/cm³)^{1/2}.

In various embodiments, coupling solvents may have (a) a coupling ability for mineral spirits and water at a volume fraction of about 90% or less and (b) δ_{P} value of about 2 (cal/cm³)^{1/2} to about 5 (cal/cm³)^{1/2} vs. a δ_{H} value of about 4 (cal/cm³)^{1/2} to about 8 (cal/cm³)^{1/2}, on a Hansen solubility parameter diagram. In various embodiments, coupling solvents may have (a) a coupling ability for mineral spirits and water at a volume fraction of about 85% or less and (b) δ_{P} value of about 2 (cal/cm³)^{1/2} to about 4.5 (cal/cm³)^{1/2} vs. a δ_{H} value of about 4.5 (cal/cm³)^{1/2} to about 7 (cal/cm³)^{1/2}, on a Hansen solubility parameter diagram. In various embodiments, coupling solvents may have (a) a coupling ability for mineral spirits and water at a volume fraction of about 75% or less and (b) &p value of about 3 (cal/cm³)^{1/2} to about 4.5 (cal/cm³)^{1/2} vs. a δ_{H} value of about 5.5 (cal/cm³)^{1/2} to about 6 (cal/cm³)^{1/2}, on a Hansen solubility parameter diagram.

In the present disclosure, at least a majority (on a volume basis unless otherwise specified) of the coupling solvent may comprise or consist of a glycol coupling solvent, a glycol ether coupling solvent, or any combination thereof. The glycol coupling solvent, glycol ether coupling solvent, or any combination thereof may meet the Hansen solubility parameters specified above. Suitable examples of glycol coupling solvents and glycol ether coupling solvents are specified further below. Optionally, monohydric alcohol coupling solvents may be used in combination with a glycol coupling solvent and/or a glycol ether coupling solvent, provided that the monohydric alcohol is present in the coupling solvent in a lower amount than the glycol coupling solvent and/or the glycol ether coupling solvent. If present, monohydric alcohols are present in the coupling solvent at about 45 wt % or less, or about 40 wt % or less, or about 35 wt % or less, or about 30 wt % or less, or about 25 wt % or less, or about 20 wt % or less, or about 15 wt % or less, or about 10 wt % or less, or about 5 wt % or less, or about 1 wt % or less, based on total volume of the coupling solvent.

At least a majority of the coupling solvent may comprise or consist of a glycol coupling solvent and/or a glycol ether coupling solvent. Suitable examples of glycol coupling solvents may include, but are not limited to, hexylene glycol. Suitable examples of glycol ether coupling solvents may include, but are not limited to, ethylene glycol monobutyl ether, ethylene glycol monoisobutyl ether, diethylene glycol monobutyl ether, ethylene glycol monoisopropyl ether, tripropylene glycol monomethyl ether, dipropylene glycol monomethyl ether, ethylene glycol monoethyl ether, propylene glycol monomethyl ether, ethylene glycol monomethyl ether, diethylene glycol monoethyl ether, the like, and any combination thereof. In more particular embodiments, the glycol ether coupling solvent may be selected from ethylene glycol monobutyl ether, ethylene glycol monoisobutyl ether, diethylene glycol monobutyl ether, or any combination thereof.

If present in combination with a glycol coupling solvent and/or a glycol ether coupling solvent, suitable alcohol coupling solvents may include aliphatic alcohols, cycloaliphatic alcohols, the like, and any combination thereof. Examples of suitable alcohol coupling solvents may include, but are not limited to, tert-butyl alcohol, n-butyl alcohol, isopropyl alcohol, tetrahydrofurfuryl alcohol, cyclohexanol, diacetone alcohol, the like, and any combination thereof.

In preferred embodiments, the aqueous dispersions disclosed herein do not contain an alcohol coupling solvent, such as a monohydric alcohol.

Aqueous dispersions of ECA copolymers of the present disclosure may have various amounts of the coupling solvent. In various embodiments, the aqueous dispersions of ECA copolymers may have about 30 wt % or less or about 25 wt % or less of the coupling solvent, based on total mass of the aqueous dispersion, including all wt % values and subranges in between, such as about 20 wt % or less, or about 18 wt % or less, or about 15 wt % or less, or about 12 wt % or less, or about 10 wt % or less, or about 8 wt % or less, or about 5 wt % or less. In various embodiments, the aqueous dispersions of CA copolymers may have about 1 wt % to about 25 wt % of the coupling solvent, based on total mass of the aqueous dispersion, including all wt % values and subranges in between, such as about 2 wt % to about 25 wt %, or about 3 wt % to about 25 wt %, or about 4 wt % to about 25 wt %, or about 5 wt % to about 25 wt %, or about 6 wt % to about 25 wt %, or about 7 wt % to about 25 wt %, or about 8 wt % to about 25 wt %, or about 9 wt % to about 25 wt %, or about 10 wt % to about 25 wt %, or about 12 wt % to about 25 wt %, or about 14 wt % to about 25 wt %, or about 16 wt % to about 25 wt %, or about 18 wt % to about 25 wt %, or about 20 wt % to about 25 wt %, or about 22 wt % to about 25 wt %, or about 24 wt % to about 25 wt %, or about 1 wt % to about 20 wt %, or about 2 wt % to about 20 wt %, or about 3 wt % to about 20 wt %, or about 4 wt % to about 20 wt %, or about 5 wt % to about 20 wt %, or about 6 wt % to about 20 wt %, or about 7 wt % to about 20 wt %, or about 8 wt % to about 20 wt %, or about 9 wt % to about 20 wt %, or about 10 wt % to about 20 wt %, or about 12 wt % to about 20 wt %, or about 14 wt % to about 20 wt %, or about 16 wt % to about 20 wt %, or about 18 wt % to about 20 wt %, or about 1 wt % to about 5 wt %, or about 5 wt % to about 10 wt %, or about 10 wt % to about 15 wt %, or about 15 wt % to about 20 wt %, or about 1 wt % to about 10 wt %, or about 2 wt % to about 12 wt %, or about 3 wt % to about 13 wt %, or about 4 wt % to about 14 wt %, or about 8 wt % to about 18 wt %, or about 12 wt % to about 22 wt %, or about 15 wt % to about 25 wt %, or about 5 wt % to about 20 wt %.

In some or other various embodiments, the aqueous dispersions of ECA copolymers may contain a mass ratio of coupling solvent:ECA copolymer ranging from about 0.05:1 to about 0.7:1, including all wt % values and subranges in between, such as about 0.05:1 to about 0.6:1, or about 0.1:1 to about 0.6:1, or about 0.15:1 to about 0.55:1, or about 0.1:1 to about 0.4:1, or about 0.25:1 to about 0.6:1.

The aqueous dispersions of ECA copolymers may further include other components such as, but not limited to, cosolvents, such as alcohols, organic acids, amines, aldehydes, ketones, esters, or other polar organic compounds, and/or inorganic or organic salts, dissolved in the aqueous-based carrier fluid. When present, these components may modify at least one property of the aqueous dispersions, such as density or ionic concentration, or promote crosslinking of the ECA copolymers. Examples of salts that may be present in the aqueous-based carrier fluid include, but are not limited to, metal salts or metal-free salts. Metal salts may comprise sodium salts, calcium salts, cesium salts, zinc salts, aluminum salts, magnesium salts, potassium salts, strontium salts, silicates, lithium salts, the like, or any combination thereof. Metal-free salts may comprise ammonium salts and/or amine salts. The metal salts and/or the metal-free salts may be in the form of chlorides, bromides, carbonates, hydroxides, iodides, chlorates, bromates, formates, nitrates, sulfates, phosphates, oxides, fluorides, the like, or any combination thereof.

The aqueous dispersions of the present disclosure may have various pH values. In various embodiments, the aqueous dispersions of the present disclosure have a pH value of about 7.0 to about 11, including all pH values and subranges in between, such as about 7 to about 10.5, or about 7 to about 10, or about 7 to about 9.5, or about 7 to about 9, or about 7 to about 8.5, or about 7 to about 8, or about 7 to about 7.5, or about 7.5 to about 11, or about 7.5 to about 10.5, or about 7.5 to about 10, or about 7.5 to about 9.5, or about 7.5 to about 9, or about 7.5 to about 8.5, or about 7.5 to about 8, or about 8 to about 11, or about 8 to about 10.5, or about 8 to about 10, or about 8 to about 9.5, or about 8 to about 9, or about 8 to about 8.5, or about 8.5 to about 11, or about 8.5 to about 10.5, or about 8.5 to about 10, or about 8.5 to about 9.5, or about 8.5 to about 9, or about 9 to about 11, or about 9 to about 10.5, or about 9 to about 10, or about 9 to about 9.5, or about 9.5 to about 11, or about 9.5 to about 10.5, or about 9.5 to about 10, or about 10 to about 11, or about 10 to about 10.5, or about 10.5 to about 11. In various embodiments, aqueous dispersions of ECA copolymers may have a pH value of about 7.5 to about 11, or about 7.5 to about 10, or about 8 to about 10, or about 7.5 to about 9.5, including all pH values and subranges in between.

The aqueous dispersions of the present disclosure may have various amounts of ECA copolymer solids as determined by gravimetric analysis (e.g., using a moisture balance, such as the OHAUS® Moisture Balance), or the like. In various embodiments, the aqueous dispersions of the present disclosure may have about 10 wt % or greater of ECA copolymer solids, including all wt % values and subranges in between, such as about 15 wt % or greater, or about 20 wt % or greater, or about 25 wt % or greater, or about 30 wt % or greater, or about 40 wt % or greater, or about 50 wt % or greater. In various embodiments, the aqueous dispersions of the present disclosure may have about 10 wt % to about 50 wt % of ECA copolymer solids, including all wt % values and subranges in between, such as about 10 wt % to about 40 wt %, or about 10 wt % to about 30 wt %, or about 10 wt % to about 25 wt %, or about 10 wt % to about 20 wt %, or about 20 wt % to about 50 wt %, or about 20 wt % to about 40 wt %, or about 20 wt % to about 30 wt %, or about 20 wt % to about 25 wt %, or about 25 wt % to about 50 wt %, or about 25 wt % to about 40 wt %, or about 25 wt % to about 30 wt %, or about 30 wt % to about 50 wt %, or about 30 wt % to about 40 wt %, or about 40 wt % to about 50 wt %.

The aqueous dispersions of the present disclosure may include ECA copolymer particles of various sizes and size dispersity values, as measured by laser diffraction (e.g., by a Malvern MASTERSIZER 3000), dynamic light scattering (DLS), small angle X-ray scattering (SAXS), or the like. In various embodiments, the aqueous dispersions of the present disclosure may comprise particles having a D50 particle size of 0.5 μm or less, including all values and subranges in between, as determined by laser diffraction or the like, such as about 0.45 μm or less, or about 0.4 μm or less, or about 0.35 μm or less, or about 0.3 μm or less, or about 0.25 μm or less, or about 0.2 μm or less, or about 0.15 μm or less, or about 0.1 μm or less. In various embodiments, the aqueous dispersions of the present disclosure may comprise particles having a D50 particle size of about 0.1 μm to about 0.5 μm, including all values and subranges in between, as determined by laser diffraction or the like, such as about 0.15 μm to about 0.5 μm, or about 0.20 μm to about 0.5 μm, or about 0.25 μm to about 0.5 μm, or about 0.30 μm to about 0.5 μm, or about 0.35 μm to about 0.5 μm, or about 0.4 μm to about 0.5 μm, or about 0.1 μm to about 0.45 μm, or about 0.15 μm to about 0.45 μm, or about 0.20 μm to about 0.45 μm, or about 0.25 μm to about 0.45 μm, or about 0.30 μm to about 0.45 μm, or about 0.35 μm to about 0.45 μm, or about 0.4 μm to about 0.45 μm, or about 0.1 μm to about 0.40 μm, or about 0.15 μm to about 0.40 μm, or about 0.20 μm to about 0.40 μm, or about 0.25 μm to about 0.40 μm, or about 0.30 μm to about 0.40 μm, or about 0.35 μm to about 0.40 μm, or about 0.1 μm to about 0.35 μm, or about 0.15 μm to about 0.35 μm, or about 0.20 μm to about 0.35 μm, or about 0.25 μm to about 0.35 μm, or about 0.30 μm to about 0.35 μm, or about 0.1 μm to about 0.30 μm, or about 0.15 μm to about 0.30 μm, or about 0.20 μm to about 0.30 μm, or about 0.25 μm to about 0.30 μm, or about 0.1 μm to about 0.25 μm, or about 0.15 μm to about 0.25 μm, or about 0.20 μm to about 0.25 μm, or about 0.1 μm to about 0.20 μm, or about 0.15 μm to about 0.20 μm, or about 0.1 μm to about 0.15 μm. In more specific embodiments, the particles comprising an ECA copolymer having 16 wt % or less, such as from about 8 wt % to about 16 wt %, of CA repeat units may have a D50 particle size of less than 0.2 μm, including all values and subranges in between, as determined by laser diffraction. In still more specific embodiments, the particles comprising an ECA copolymer having 16 wt % or less, such as from about 8 wt % to about 16 wt %, of CA repeat units may have a D50 particle size of about 0.05 μm to about 0.2 μm, including all values and subranges in between, as determined by laser diffraction.

The aqueous dispersions of the present disclosure may have various viscosity values, as measured by a viscometer or the like, such as a Brookfield viscometer where the viscosity is measured at 23° C. using LV Spindles #1-4, depending upon the sample viscosity. The viscosity of the aqueous dispersions of the present disclosure may be at a moderate level (e.g., about 1000 centipoise (cP) or less and preferably about 600 cP or less, such as, but not limited to, about 10 cP to about 600 cP, or about 10 cP to about 100 cP, or about 100 cP to about 200 cP, or about 200 cP to about 300 cP, or about 300 cP to about 400 cP, or about 400 cP to about 500 cP, or about 500 cP to about 600 cP) to provide a water-borne coating formulation comprising said aqueous dispersion in an even coating while still being readily processible. Even higher viscosity values up to about 5000 cP, or up to about 4000 cP, or up to about 3000 cP, or up to about 2000 cP may also be tolerated. Such higher viscosity values may be attained by withholding water during formulation of the aqueous dispersions. A higher neutralization degree for the ECA copolymer may increase the viscosity of a water-borne coating formulation, and when the neutralization degree is too high, the mixture may become unprocessible. A lower neutralization degree for the ECA copolymer may not fully disperse and/or stabilize the ECA copolymer within the dispersion, resulting in unstable, micron-sized or greater particulates. The amount of ECA copolymer and the neutralization degree of the ECA copolymer may both be altered to provide appropriate viscosities for the dispersion. Viscosity may also be affected by the type of neutralizing agent (e.g., ammonia vs. tertiary amine) or the type of coupling solvent. Each of these constituents influence how the dispersed particles interact with the continuous phase. Other characteristics (e.g., solids content, the dielectric constant of the continuous phase) also impact the resulting viscosity of the dispersion.

In various embodiments, the aqueous dispersions of the present disclosure may have viscosities of about 100 cP to about 600 cP, including all values and subranges in between, as measured by a Brookfield viscometer (LV-3 spindle, at 60 rotations per minute (rpm)), such as about 100 cP to about 500 cP, or about 100 cP to about 400 cP, or about 100 cP to about 300 cP, or about 100 cP to about 200 cP, or about 200 cP to about 600 cP, or about 200 cP to about 500 cP, or about 200 cP to about 400 cP, or about 200 cP to about 300 cP, or about 300 cP to about 600 cP, or about 300 cP to about 500 cP, or about 300 cP to about 400 cP, or about 400 cP to about 600 cP, or about 400 cP to about 500 cP, or about 500 cP to about 600 cP.

Accordingly, in some examples, aqueous dispersions of the present disclosure may comprise: a continuous phase comprising an aqueous-based carrier fluid and a coupling solvent; and particles dispersed in the continuous phase and comprising at least one ECA copolymer; wherein the particles have a D50 particle size of about 1 μm or less, such as about 0.1 μm or less, as determined by laser diffraction, and the at least one ECA has a melt flow index (MFI) of about 100 grams/10 min or less, such as about 60 grams/10 min or less, or about 30 grams/10 min or less, or 10 grams/10 min or less, as measured at 190° C. under a load of 2.16 kg in accordance with ASTM D1238, and 20 wt % or less of carboxylic acid (CA) repeat units, such as 19 wt % or less, 15 wt % or less, 11 wt % or less, or 8 wt % or less; wherein said CA repeat units comprise one or more CA groups, and wherein at least a portion of the CA groups are neutralized. The portion of the neutralized CA groups may be neutralized with a volatile base comprising at least ammonia. In various embodiments, the volatile base may consist of ammonia. In various embodiments, the base may be free of metal-containing bases.

In some or other examples, aqueous dispersions of the present disclosure may comprise: a continuous phase comprising an aqueous-based carrier fluid, and a coupling solvent; a base; and particles dispersed in the continuous phase and comprising at least one ethylene-carboxylic acid (ECA) copolymer comprising a plurality of carboxylic acid (CA) groups, and at least a portion of the CA groups are neutralized by at least a portion of the base. The ECA copolymer has an acid value of about 70 milligrams of KOH per gram copolymer (mg KOH/g copolymer) to about 125 mg KOH/g copolymer.

The acid value may be determined using a modification of ASTM D1386-15 (2022). For example, the acid value may be determined, in general, by titration against a standardized base. If the amount of acid-containing monomers in the ECA copolymer is known, the acid number may be calculated by dividing the amount of acid-containing monomer in grams by the molecular weight of the acid-containing monomer, multiplying by the molecular weight of KOH, and finally multiplying the result by 1000.

At least one of the following conditions may be met when formulating the aqueous dispersions of the present disclosure: Condition a) the coupling solvent comprises a glycol ether coupling solvent; Condition b) the base consists of ammonia, and/or Condition c) the ECA copolymer has an acid value of about 70 mg KOH/g copolymer to about 117 mg KOH/g copolymer, and the aqueous dispersion has a pH value of about 7.5 to about 10, or about 7.5 to about 9.5, or about 7.5 to about 8.5, or about 7.5 to about 8, or about 8 to about 9.5, or about 8 to about 9.

If Condition a) is met, the base may comprise ammonia, an amine, a metal-containing base, and any combination thereof. The base may comprise at least one amine, such as monocthanolamine (MEA), diethanolamine (DEA), triethanolamine (TEA), aminomethylpropanol (AMP), dimethylaminomethylpropanol (DMAMP), dimethylaminocthanol (DMAE), diethylaminoethanol (DEAE), dimethylaminopropanol (DMAP), and any combination thereof. The aqueous dispersion may have a pH value of about 7.5 to about 11, or about 8 to about 11, or about 7.5 to about 10, or about 8 to about 10.

If Condition b) and/or Condition c) is met, the coupling solvent may comprise an alcohol coupling solvent, a glycol coupling solvent, a glycol ether coupling solvent, or any combination thereof. The coupling solvent may comprise an alcohol coupling solvent comprising at least one member selected from the group consisting of tert-butyl alcohol, n-butyl alcohol, isopropyl alcohol, tetrahydrofurfuryl alcohol, cyclohexanol, diacetone alcohol, and any combination thereof; and/or the coupling solvent may comprise a glycol ether coupling solvent comprising at least one member selected from the group consisting of ethylene glycol monobutyl ether, ethylene glycol monoisobutyl ether, diethylene glycol monobutyl ether, ethylene glycol monoisopropyl ether, tripropylene glycol monomethyl ether, dipropylene glycol monomethyl ether, ethylene glycol monomethyl ether, propylene glycol monomethyl ether, ethylene glycol monomethyl ether, diethylene glycol monomethyl ether, and any combination thereof; and/or the coupling solvent may comprise a glycol coupling solvent comprising hexylene glycol.

If Condition a) and/or Condition b) is met, the aqueous dispersion may have a pH value of about 7.5 to about 11, or about 7.5 to about 10, or about 8 to about 11, or about 8 to about 10. If Condition c) is met, the aqueous dispersion may have a pH value of about 7.5 to about 10, or about 7.5 to about 9.5, or about 7.5 to about 9, or about 7.5 to about 8.5, or about 7.5 to about 8, or about 8 to about 9.5, or about 8 to about 9.

If Condition c) is met, the base may comprise at least one member selected from the group consisting of ammonia, an amine, a metal-containing base, and any combination thereof. The base may comprise at least one amine selected from the group consisting of monoethanolamine (MEA), dicthanolamine (DEA), tricthanolaminc (TEA), aminomethylpropanol (AMP), dimethylaminomethylpropanol (DMAMP), dimethylaminocthanol (DMAE), dicthylaminocthanol (DEAE), dimethylaminopropanol (DMAP), and any combination thereof.

If Condition c) is met, the coupling solvent may comprise an alcohol coupling solvent, a glycol coupling solvent, a glycol ether coupling solvent, or any combination thereof. The coupling solvent may comprise an alcohol coupling solvent comprising at least one member selected from the group consisting of tert-butyl alcohol, n-butyl alcohol, isopropyl alcohol, tetrahydrofurfuryl alcohol, cyclohexanol, diacetone alcohol, and any combination thereof; and/or the coupling solvent may comprise a glycol ether coupling solvent comprising at least one member selected from the group consisting of ethylene glycol monobutyl ether, ethylene glycol monoisobutyl ether, diethylene glycol monobutyl ether, ethylene glycol monoisopropyl ether, tripropylene glycol monomethyl ether, dipropylene glycol monomethyl ether, ethylene glycol monomethyl ether, propylene glycol monomethyl ether, ethylene glycol monomethyl ether, diethylene glycol monomethyl ether, and any combination thereof; and/or the coupling solvent may comprise a glycol coupling solvent comprising hexylene glycol.

The aqueous dispersions of the present disclosure may be utilized in water-borne coating applications, either alone or when combined with other application-specific additives. Suitable examples of additives will be familiar to one having ordinary skill in the art. Aqueous dispersions of ECA copolymers may suitably form barrier coatings, printing primer, adhesive adhesion primer, or any combination thereof. Aqueous dispersions of ECA copolymers may be suitable as a heat seal adhesive when deposited upon a surface. Aqueous dispersions of ECA copolymers may be applied directly to various polar substrates, such as aluminum, steel, and the like, such as barrier coatings for food and beverage cans, industrial anti-corrosion coatings for steel or aluminum, and the like.

In various embodiments, the aqueous dispersions of the present disclosure and water-borne coating formulations obtained therefrom are used to coat metal substrates. Suitable examples of metal substrates include, but are not limited to, metal cans, the like, and any combination thereof. In various embodiments, water-borne coating formulations are suitable for coating of metal interiors and/or exteriors. Examples of metal cans which are suitable for coating with aqueous dispersions and water-borne metal coating formulations of the present disclosure may include metal beverage cans, metal food cans, the like, and any combination thereof. Water-borne coating formulations may exclude metal hydroxides as bases so that, for example, the coatings display reduced corrosion of metal substrates. Water-borne coating formulations may comprise at least one additive selected from the group consisting of surfactants, dispersants, biocides, the like, and any combination thereof. Water-borne coating formulations may exclude an additional surfactant and/or a dispersant so that, for example, coatings obtained therefrom may display improved barrier properties and reduced leaching (i.e., via reduced migration through the coating).

In various aspects, the present disclosure provides methods for producing an aqueous dispersion of an ECA copolymer. The methods may comprise: providing at least one ECA copolymer, such as an ECA copolymer as described above; forming a mixture comprising the at least one ECA copolymer, a base, a coupling solvent, and an aqueous-based carrier fluid; heating the mixture at an operation temperature of at least a melting point of the at least one ECA copolymer to form an aqueous emulsion comprising liquid droplets of the at least one ECA copolymer; and cooling the aqueous emulsion to or below a temperature at which solid particles of the ECA copolymer form and produce an aqueous dispersion comprising the solid particles dispersed in the continuous phase. At least a majority of the coupling solvent may comprise a glycol coupling solvent, a glycol ether coupling solvent, or any combination thereof. The continuous phase may comprise at least the aqueous-based carrier fluid, the coupling solvent, and the base. The temperature at which solid particles of the ECA copolymer form may be a crystallization temperature, which may be at or below the melting point of the at least one ECA copolymer. Suitable aqueous-based carrier fluids, ECA copolymers, bases, coupling solvents, and amounts thereof are discussed in more detail above. In various embodiments, the at least one ECA copolymer may be added to the mixture in the form of beads, pellets, granules, powder, the like, or any combination thereof. In various embodiments, the at least one ECA copolymer may not be dispersible when the mixture excludes the coupling solvent.

To form the mixture, at least a portion of each of the coupling solvent, the aqueous-based carrier fluid (e.g., water), and the base may be concurrently added, or a mixture thereof may be added, to the at least one ECA copolymer; or the at least one ECA copolymer may be mixed with at least a portion of the coupling solvent, followed by sequential addition of at least a portion of the aqueous-based carrier fluid and then at least a portion of the base; or the at least one ECA copolymer may be mixed with at least a portion of the coupling solvent, followed by concurrent addition of at least a portion of each of the aqueous-based carrier fluid and the base or a mixture thereof. A portion of or all of at least one of the base, the coupling solvent, and the aqueous-based carrier fluid may be added to the mixture prior to heating. Optionally, a portion of the base, the coupling solvent, and/or the aqueous-based carrier fluid may be added following heating or cooling the mixture. The foregoing may be added in a single portion or in multiple portions, and/or either in a single addition step or in multiple addition steps. In various embodiments, the mixture initially comprises at least one ECA copolymer, while each of a base, a coupling solvent, and an aqueous-based carrier fluid are each added to the initial mixture in one or more portions and during one or more additional steps of the method.

In various embodiments, one or more steps of the methods may be performed in a reaction vessel. In various embodiments, the reaction vessel may be a pressure vessel, e.g., a Parr reactor. In various embodiments, one or more steps of the method may be performed under pressure. In various embodiments, one or more steps of the method may be performed at 1 atmosphere (atm) of pressure or greater.

In various embodiments, one or more steps of the method may be performed under agitation. In various embodiments, the methods may utilize a single agitation setting (e.g., different mixing speeds, flow rates, pressures, or the like) for the duration of the agitation process. In various embodiments, the methods may utilize two or more different agitation settings at two or more different periods of time during the agitation process. Methods may be achieved by agitation at low shear using low shear mixing devices (e.g., impeller blades, or the like) and low shear mixing conditions (e.g., low rotations per minute (rpm), or low flow rates, or low pressure) to reduce shearing between particles and/or shearing between particles and a reaction vessel wall). The methods may be conducted by agitation excluding high shear, e.g., by excluding use of high shear mixing devices (e.g., homogenizers (e.g., rotor-stator mixers), dispersion blades (e.g., Cowles blades), or the like) and high shear mixing conditions (e.g., high rpm, high flow rates, high pressure). In various embodiments, the methods may be performed under agitation consisting of low shear agitation (e.g., consisting of mixing at low mixing speeds, low flow rates, or low pressures).

The methods may be performed under agitation consisting of low mixing speed. As used herein, “low mixing speed,” and grammatical variations thereof, generally refer to mixing speeds of less than about 1000 rpm, including all rpm values and subranges in between, such as less than about 900 rpm, or less than about 800 rpm, or less than about 700 rpm, or less than about 600 rpm, or less than about 500 rpm, or less than about 400 rpm, or less than about 300 rpm, or less than about 200 rpm, or less than about 100 rpm, or about 900 rpm, or about 800 rpm, or about 700 rpm, or about 600 rpm, or about 500 rpm, or about 400 rpm, or about 300 rpm, or about 200 rpm, or about 100 rpm, or about 100 rpm to less than about 1000 rpm, including all rpm values and subranges in between, such as about 150 rpm to about 900 rpm, or about 200 rpm to about 800 rpm, or about 250 rpm to about 700 rpm, or about 100 rpm to about 600 rpm, or about 150 rpm to about 500 rpm, or about 200 rpm to about 400 rpm, or about 300 rpm to less than about 1000 rpm, or about 350 rpm to about 900 rpm, or about 400 rpm to about 800 rpm, or about 500 rpm to about 700 rpm. Methods may be performed under a single low mixing speed or under two or more different low mixing speeds each independently selected for use at various points of time and for different lengths of time during agitation. In various embodiments, methods are performed under at least one mixing speed of about 250 rpm to about 700 rpm.

In various embodiments, heating the mixture may be performed until the mixture achieves a temperature greater than the melting point of the at least one ECA copolymer. The temperature may be about 70° C. to about 120° C., including all values and subranges in between, such as about 80° C. to about 115° C., or about 90° C. to about 110° C. In various embodiments, heating the mixture may occur under pressure, preferably at a pressure of 1 atm or greater. Heating may be performed until all of the ECA copolymer has formed a molten phase (polymer melt) within the mixture, preferably as molten droplets dispersed within a continuous phase comprising the aqueous-based carrier fluid. Heating may be performed until molten droplets dispersed within the continuous phase of the mixture are reduced to a desired particle size or particle size dispersity, such as the illustrative particle sizes disclosed above.

In various embodiments, one or more various steps of the methods (i.e., forming the mixture, and/or cooling the mixture) may be performed under the same or reduced reaction conditions (e.g., temperature, pressure, and/or agitation speed) as specified for the heating step. For example, forming the mixture or other method steps may be performed without pressure and/or without heating.

In various embodiments, cooling the mixture may be performed until the temperature of the mixture is below the temperature specified for the heating and/or the holding steps. In various embodiments, cooling the mixture may be performed until the mixture is cooled to below the boiling point of water. In various embodiments, cooling the mixture may be performed until the ECA copolymer particles have cooled to a temperature below which particles comprising the ECA copolymer form, such as below a crystallization temperature of the ECA copolymer, thereby forming an aqueous dispersion comprising solidified particles of the ECA copolymer dispersed therein. In various embodiments, cooling may be performed until the temperature of the mixture reaches room temperature. In various embodiments, cooling the mixture may be performed under pressure. In various embodiments, the pressure may be 1 atm pressure or greater. In various embodiments, cooling the mixture may be performed with agitation at an agitation rate lower than the specified agitation rate for heating the mixture.

Embodiments disclosed herein include:

Embodiment 1. An aqueous dispersion comprising:
a continuous phase comprising an aqueous-based carrier fluid, and a coupling solvent;
a base; and
particles dispersed in the continuous phase and comprising at least one ethylene-carboxylic acid (ECA) copolymer comprising a plurality of carboxylic acid (CA) groups, and at least a portion of the CA groups are neutralized by at least a portion of the base;
   wherein the at least one ECA copolymer has an acid value of about 70 milligrams of KOH per gram copolymer (mg KOH/g copolymer) to about 125 mg KOH/g copolymer;
      wherein at least one of the following conditions is met:
      Condition a) the coupling solvent comprises a glycol ether coupling solvent;
      Condition b) the base consists of ammonia; and/or
      Condition c) the at least one ECA copolymer has an acid value of about 70 mg KOH/g copolymer to about 117 mg KOH/g copolymer, and the aqueous dispersion has a pH value of about 7.5 to about 10.

Embodiment 2. The aqueous dispersion of Embodiment 1, wherein the at least one ECA copolymer is an ethylene-(meth)acrylic acid (E(M)AA) copolymer comprising methacrylic acid (MAA) and/or acrylic acid (AA) repeat units.

Embodiment 3. The aqueous dispersion of Embodiment 1 or Embodiment 2, wherein the at least one ECA copolymer has a melt flow index (MFI) at 190° C. of about 5 g/10 min to about 70 g/10 min.

Embodiment 4. The aqueous dispersion of Embodiment 1 or Embodiment 2, wherein Condition a) is met, and the base comprises at least one member selected from the group consisting of ammonia, an amine, a metal-containing base, and any combination thereof.

Embodiment 5. The aqueous dispersion of Embodiment 4, wherein the base comprises at least one amine selected from the group consisting of monoethanolamine (MEA), diethanolamine (DEA), triethanolamine (TEA), aminomethylpropanol (AMP), dimethylaminomethylpropanol (DMAMP), dimethylaminoethanol (DMAE), diethylaminoethanol (DEAE), dimethylaminopropanol (DMAP), and any combination thereof.

Embodiment 6. The aqueous dispersion of Embodiment 4, wherein the aqueous dispersion has a pH value of about 7.5 to about 11.

Embodiment 7. The aqueous dispersion of Embodiment 1 or Embodiment 2, wherein Condition b) and/or Condition c) is met, and the coupling solvent comprises an alcohol coupling solvent, a glycol coupling solvent, a glycol ether coupling solvent, or any combination thereof.

Embodiment 8. The aqueous dispersion of Embodiment 7, wherein:
the coupling solvent comprises an alcohol coupling solvent, and the alcohol coupling solvent comprises at least one member selected from the group consisting of tert-butyl alcohol, n-butyl alcohol, isopropyl alcohol, tetrahydrofurfuryl alcohol, cyclohexanol, diacetone alcohol, and any combination thereof;
the coupling solvent comprises a glycol ether coupling solvent, and the glycol ether coupling solvent comprises at least one member selected from the group consisting of ethylene glycol monobutyl ether, ethylene glycol monoisobutyl ether, diethylene glycol monobutyl ether, ethylene glycol monoisopropyl ether, tripropylene glycol monomethyl ether, dipropylene glycol monomethyl ether, ethylene glycol monomethyl ether, propylene glycol monomethyl ether, ethylene glycol monomethyl ether, diethylene glycol monomethyl ether, and any combination thereof; and/or
the coupling solvent comprises a glycol coupling solvent, and the glycol coupling solvent comprises hexylene glycol.

Embodiment 9. The aqueous dispersion of Embodiment 7, wherein the coupling solvent comprises or consists of the glycol ether coupling solvent.

Embodiment 10. The aqueous dispersion of Embodiment 1 or Embodiment 2, wherein Condition a) and/or Condition b) is met, and the aqueous dispersion has a pH value of about 7.5 to about 11.

Embodiment 11. The aqueous dispersion of Embodiment 1 or Embodiment 2, wherein Condition c) is met, and the aqueous dispersion has a pH value of about 7.5 to about 9.5.

Embodiment 12. The aqueous dispersion of Embodiment 1 or Embodiment 2, wherein Condition c) is met, and the base comprises at least one member selected from the group consisting of ammonia, an amine, a metal-containing base, and any combination thereof.

Embodiment 13. The aqueous dispersion of Embodiment 12, wherein the base comprises at least one amine selected from the group consisting of monoethanolamine (MEA), diethanolamine (DEA), triethanolamine (TEA), aminomethylpropanol (AMP), dimethylaminomethylpropanol (DMAMP), dimethylaminoethanol (DMAE), diethylaminoethanol (DEAE), dimethylaminopropanol (DMAP), and any combination thereof.

Embodiment 14. The aqueous dispersion of Embodiment 1 or Embodiment 2, wherein Condition c) is met, and the coupling solvent comprises an alcohol coupling solvent, a glycol coupling solvent, a glycol ether coupling solvent, or any combination thereof.

Embodiment 15. The aqueous dispersion of Embodiment 14, wherein:
the coupling solvent comprises an alcohol coupling solvent, and the alcohol coupling solvent comprises at least one member selected from the group consisting of tert-butyl alcohol, n-butyl alcohol, isopropyl alcohol, tetrahydrofurfuryl alcohol, cyclohexanol, diacetone alcohol, and any combination thereof;
the coupling solvent comprises a glycol ether coupling solvent, and the glycol ether coupling solvent comprises at least one member selected from the group consisting of ethylene glycol monobutyl ether, ethylene glycol monoisobutyl ether, diethylene glycol monobutyl ether, ethylene glycol monoisopropyl ether, tripropylene glycol monomethyl ether, dipropylene glycol monomethyl ether, ethylene glycol monomethyl ether, propylene glycol monomethyl ether, ethylene glycol monomethyl ether, diethylene glycol monomethyl ether, and any combination thereof; and/or
the coupling solvent comprises a glycol coupling solvent, and the glycol coupling solvent comprises hexylene glycol.

Embodiment 16. The aqueous dispersion of Embodiment 14, wherein the coupling solvent comprises or consists of the glycol ether coupling solvent.

Embodiment 17. The aqueous dispersion of Embodiment 1 or Embodiment 2 or any one of Embodiments 1-16, wherein a mass ratio of coupling solvent:ECA copolymer in the aqueous dispersion ranges from about 0.05 to about 0.7.

Embodiment 18. The aqueous dispersion of Embodiment 1 or Embodiment 2 or any one of Embodiments 1-17, wherein the base comprises at least one member selected from the group consisting of ammonia, an amine, a metal-containing base, and any combination thereof.

Embodiment 19. The aqueous dispersion of Embodiment 18, wherein the base comprises at least one amine selected from the group consisting of monoethanolamine (MEA), diethanolamine (DEA), triethanolamine (TEA), aminomethylpropanol (AMP), dimethylaminomethylpropanol (DMAMP), dimethylaminoethanol (DMAE), diethylaminoethanol (DEAE), dimethylaminopropanol (DMAP), and any combination thereof.

Embodiment 20. The aqueous dispersion of Embodiment 1 or Embodiment 2 or any one of Embodiments 1-19, wherein the particles have a D50 particle size of about 0.2 (micron) μm or less, as determined by laser diffraction.

Embodiment 21. A method for preparing an aqueous dispersion, comprising:
forming a mixture comprising:
a continuous phase comprising an aqueous-based carrier fluid, and a coupling solvent; a base; and at least one ethylene-carboxylic acid (ECA) copolymer comprising a plurality of carboxylic acid (CA) groups, and at least a portion of the CA groups are neutralized by at least a portion of the base;
   wherein the at least one ECA copolymer has an acid value of about 70 milligrams of KOH per gram copolymer (mg KOH/g copolymer) to about 125 mg KOH/g copolymer;
heating the mixture at an operation temperature of at least the melting point of the at least one ECA copolymer to form an aqueous emulsion comprising liquid droplets of the at least one ECA copolymer; and
cooling the aqueous emulsion to or below a crystallization temperature of the at least one ECA copolymer to form an aqueous dispersion comprising solid particles of the at least one ECA copolymer dispersed in the continuous phase;
   wherein at least one of the following conditions is met:
   Condition a) the coupling solvent consists of a glycol ether coupling solvent; and
   Condition b) the base consists of ammonia; and/or
   Condition c) the at least one ECA copolymer has an acid value of about 70 mg KOH/g copolymer to about 117 mg KOH/g copolymer, and the aqueous dispersion has a pH value of about 7.5 to about 10.

Embodiment 22. The method of Embodiment 21, wherein the at least one ECA copolymer is an ethylene-(meth)acrylic acid (E(M)AA) copolymer comprising methacrylic acid (MAA) and/or acrylic acid (AA) repeat units.

Embodiment 23. The method of Embodiment 21 or Embodiment 22, wherein the at least one ECA copolymer has a melt flow index (MFI) at 190° C. of about 5 g/10 min to about 70 g/10 min.

Embodiment 24. The method of Embodiment 21 or Embodiment 22, wherein Condition a) is met, and the base comprises at least one member selected from the group consisting of ammonia, an amine, a metal-containing base, and any combination thereof.

Embodiment 25. The method of Embodiment 24, wherein the base comprises at least one amine selected from the group consisting of monoethanolamine (MEA), diethanolamine (DEA), triethanolamine (TEA), aminomethylpropanol (AMP), dimethylaminomethylpropanol (DMAMP), dimethylaminoethanol (DMAE), dicthylaminocthanol (DEAE), dimethylaminopropanol (DMAP), and any combination thereof.

Embodiment 26. The method of Embodiment 24, wherein the aqueous dispersion has a pH value of about 7.5 to about 11.

Embodiment 27. The method of Embodiment 21 or Embodiment 22, wherein Condition b) and/or Condition c) is met, and the coupling solvent comprises an alcohol coupling solvent, a glycol coupling solvent, a glycol ether coupling solvent, or any combination thereof.

Embodiment 28. The method of Embodiment 27, wherein:
the coupling solvent comprises an alcohol coupling solvent, and the alcohol coupling solvent comprises at least one member selected from the group consisting of tert-butyl alcohol, n-butyl alcohol, isopropyl alcohol, tetrahydrofurfuryl alcohol, cyclohexanol, diacetone alcohol, and any combination thereof;
the coupling solvent comprises a glycol ether coupling solvent, and the glycol ether coupling solvent comprises at least one member selected from the group consisting of ethylene glycol monobutyl ether, ethylene glycol monoisobutyl ether, diethylene glycol monobutyl ether, ethylene glycol monoisopropyl ether, tripropylene glycol monomethyl ether, dipropylene glycol monomethyl ether, ethylene glycol monomethyl ether, propylene glycol monomethyl ether, ethylene glycol monomethyl ether, diethylene glycol monomethyl ether, and any combination thereof; and/or
the coupling solvent comprises a glycol coupling solvent, and the glycol coupling solvent comprises hexylene glycol.

Embodiment 29. The method of Embodiment 27, wherein the coupling solvent comprises or consists of the glycol ether coupling solvent.

Embodiment 30. The method of Embodiment 21 or Embodiment 22, wherein Condition a) and/or Condition b) is met, and the aqueous dispersion has a pH value of about 7.5 to about 11.

Embodiment 31. The method of Embodiment 21 or Embodiment 22, wherein Condition c) is met, and the aqueous dispersion has a pH value of about 7.5 to about 9.5.

Embodiment 32. The method of Embodiment 21 or Embodiment 22, wherein Condition c) is met, and the base comprises at least one member selected from the group consisting of ammonia, an amine, a metal-containing base, and any combination thereof.

Embodiment 33. The method of Embodiment 32, wherein the base comprises at least one amine selected from the group consisting of monoethanolamine (MEA), diethanolamine (DEA), triethanolamine (TEA), aminomethylpropanol (AMP), dimethylaminomethylpropanol (DMAMP), dimethylaminoethanol (DMAE), diethylaminocthanol (DEAE), dimethylaminopropanol (DMAP), and any combination thereof.

Embodiment 34. The method of Embodiment 21 or Embodiment 22, wherein Condition c) is met, and the coupling solvent comprises an alcohol coupling solvent, a glycol coupling solvent, a glycol ether coupling solvent, or any combination thereof.

Embodiment 35. The method of Embodiment 34, wherein:
the coupling solvent comprises an alcohol coupling solvent, and the alcohol coupling solvent comprises at least one member selected from the group consisting of tert-butyl alcohol, n-butyl alcohol, isopropyl alcohol, tetrahydrofurfuryl alcohol, cyclohexanol, diacetone alcohol, and any combination thereof;
the coupling solvent comprises a glycol ether coupling solvent, and the glycol ether coupling solvent comprises at least one member selected from the group consisting of ethylene glycol monobutyl ether, ethylene glycol monoisobutyl ether, diethylene glycol monobutyl ether, ethylene glycol monoisopropyl ether, tripropylene glycol monomethyl ether, dipropylene glycol monomethyl ether, ethylene glycol monomethyl ether, propylene glycol monomethyl ether, ethylene glycol monomethyl ether, diethylene glycol monomethyl ether, and any combination thereof; and/or
the coupling solvent comprises a glycol coupling solvent, and the glycol coupling solvent comprises hexylene glycol.

Embodiment 36. The method of Embodiment 34, wherein the coupling solvent comprises or consists of the glycol ether coupling solvent.

Embodiment 37. The method of Embodiment 21 or Embodiment 22 or any one of Embodiments 21-36, wherein a mass ratio of coupling solvent:ECA copolymer in the aqueous dispersion ranges from about 0.05 to about 0.7.

Embodiment 38. The method of Embodiment 21 or Embodiment 22 or any one of Embodiments 21-37, wherein the base comprises at least one member selected from the group consisting of ammonia, an amine, a metal-containing base, and any combination thereof.

Embodiment 39. The method of Embodiment 38, wherein the base comprises at least one amine selected from the group consisting of monoethanolamine (MEA), diethanolamine (DEA), triethanolamine (TEA), aminomethylpropanol (AMP), dimethylaminomethylpropanol (DMAMP), dimethylaminoethanol (DMAE), diethylaminoethanol (DEAE), dimethylaminopropanol (DMAP), and any combination thereof.

Embodiment 40. The method of Embodiment 21 or Embodiment 22 or any one of Embodiments 21-39, wherein the particles have a D50 particle size of about 0.2 (micron) μm or less, as determined by laser diffraction.

Additional embodiments disclosed herein include:

Embodiment 1′. An aqueous dispersion comprising:
a continuous phase comprising an aqueous-based carrier fluid, a coupling solvent, and a base;
   wherein at least a majority of the coupling solvent comprises a glycol coupling solvent, a glycol ether coupling solvent, or any combination thereof; and
particles dispersed in the continuous phase and comprising at least one ethylene-carboxylic acid (ECA) copolymer comprising a plurality of carboxylic acid (CA) groups, and at least a portion of the CA groups are neutralized by at least a portion of the base;
   wherein the at least one ECA copolymer has an acid value of about 70 milligrams of KOH per gram copolymer (mg KOH/g copolymer) to about 125 mg KOH/g copolymer.

Embodiment 2′. The aqueous dispersion of Embodiment 1′, wherein the at least one ECA copolymer is an ethylene-(meth)acrylic acid (E(M)AA) copolymer comprising methacrylic acid (MAA) and/or acrylic acid (AA) repeat units.

Embodiment 3′. The aqueous dispersion of Embodiment 1′ or Embodiment 2′, wherein the at least one ECA copolymer has a melt flow index (MFI) of about 5 g/10 min to about 70 g/10 min at 190° C. under a 2.16 kg load.

Embodiment 4′. The aqueous dispersion of any one of Embodiments 1′-3′, wherein the base comprises at least one member selected from the group consisting of ammonia, an amine, a metal-containing base, and any combination thereof.

Embodiment 5′. The aqueous dispersion of Embodiment 4′, wherein the base comprises at least one amine selected from the group consisting of monoethanolamine (MEA), diethanolamine (DEA), triethanolamine (TEA), aminomethylpropanol (AMP), dimethylaminomethylpropanol (DMAMP), dimethylaminocthanol (DMAE), diethylaminocthanol (DEAE), dimethylaminopropanol (DMAP), and any combination thereof.

Embodiment 6′. The aqueous dispersion of Embodiment 4′, wherein the base consists of ammonia.

Embodiment 7′. The aqueous dispersion of any one of Embodiments 4′-6′, wherein the aqueous dispersion has a pH value of about 7.5 to about 11.

Embodiment 8′. The aqueous dispersion of any one of Embodiments 1′-6′, wherein the base consists of ammonia; and/or the at least one ECA copolymer has an acid value of about 70 mg KOH/g copolymer to about 117 mg KOH/g copolymer, and the aqueous dispersion has a pH value of about 7.5 to about 10.

Embodiment 9′. The aqueous dispersion of any one of Embodiments 1′-8′, wherein the glycol ether coupling solvent comprises at least one member selected from the group consisting of ethylene glycol monobutyl ether, ethylene glycol monoisobutyl ether, diethylene glycol monobutyl ether, ethylene glycol monoisopropyl ether, tripropylene glycol monomethyl ether, dipropylene glycol monomethyl ether, ethylene glycol monomethyl ether, propylene glycol monomethyl ether, ethylene glycol monomethyl ether, diethylene glycol monomethyl ether, and any combination thereof; and/or the glycol coupling solvent comprises hexylene glycol.

Embodiment 10′. The aqueous dispersion of any one of Embodiments 1′-9′, wherein the coupling solvent comprises or consists of the glycol ether coupling solvent.

Embodiment 11′. The aqueous dispersion of any one of Embodiments 1′-10′, wherein the at least one ECA copolymer has an acid value of about 70 mg KOH/g copolymer to about 117 mg KOH/g copolymer, and the aqueous dispersion has a pH value of about 7.5 to about 9.5.

Embodiment 12′. The aqueous dispersion of Embodiment 11′, wherein the base comprises at least one member selected from the group consisting of ammonia, an amine, a metal-containing base, and any combination thereof.

Embodiment 13′. The aqueous dispersion of Embodiment 12′, wherein the base comprises at least one amine selected from the group consisting of monoethanolamine (MEA), diethanolamine (DEA), triethanolamine (TEA), aminomethylpropanol (AMP), dimethylaminomethylpropanol (DMAMP), dimethylaminoethanol (DMAE), diethylaminoethanol (DEAE), dimethylaminopropanol (DMAP), and any combination thereof.

Embodiment 14′. The aqueous dispersion of Embodiment 12′, wherein the base consists of ammonia.

Embodiment 15′. The aqueous dispersion of any one of Embodiments 1′-14′, wherein a mass ratio of coupling solvent:ECA copolymer in the aqueous dispersion ranges from about 0.05 to about 0.7.

Embodiment 16′. The aqueous dispersion of any one of Embodiments 1′-15′, wherein the particles have a D50 particle size of about 0.2 (micron) μm or less, as determined by laser diffraction.

Embodiment 17′. The aqueous dispersion of any one of Embodiments 1′-16′, wherein the ECA copolymer comprises or consists of ethylene-acrylic acid (EAA).

Embodiment 18′. A method for preparing an aqueous dispersion, comprising:
forming a mixture comprising:
   a continuous phase comprising an aqueous-based carrier fluid, a coupling solvent, and a base;
      wherein at least a majority of the coupling solvent comprises a glycol coupling solvent, a glycol ether coupling solvent, or any combination thereof; and
   at least one ethylene-carboxylic acid (ECA) copolymer comprising a plurality of carboxylic acid (CA) groups, and at least a portion of the CA groups are neutralized by at least a portion of the base;
      wherein the at least one ECA copolymer has an acid value of about 70 milligrams of KOH per gram copolymer (mg KOH/g copolymer) to about 125 mg KOH/g copolymer;
heating the mixture at an operation temperature of at least the melting point of the at least one ECA copolymer to form an aqueous emulsion comprising liquid droplets of the at least one ECA copolymer; and
cooling the aqueous emulsion to or below a temperature at which solid particles of the ECA copolymer form and produce an aqueous dispersion comprising the solid particles dispersed in the continuous phase.

Embodiment 19′. The method of Embodiment 18′, wherein the at least one ECA copolymer is an ethylene-(meth)acrylic acid (E(M)AA) copolymer comprising methacrylic acid (MAA) and/or acrylic acid (AA) repeat units.

Embodiment 20′. The method of Embodiment 18′ or Embodiment 19′, wherein the at least one ECA copolymer has a melt flow index (MFI) of about 5 g/10 min to about 70 g/10 min at 190° C. under a 2.16 kg load.

Embodiment 21′. The method of any one of Embodiments 18′-20′, wherein the base comprises at least one member selected from the group consisting of ammonia, an amine, a metal-containing base, and any combination thereof.

Embodiment 22′. The method of Embodiment 21′, wherein the base comprises at least one amine selected from the group consisting of monoethanolamine (MEA), diethanolamine (DEA), triethanolamine (TEA), aminomethylpropanol (AMP), dimethylaminomethylpropanol (DMAMP), dimethylaminoethanol (DMAE), diethylaminoethanol (DEAE), dimethylaminopropanol (DMAP), and any combination thereof.

Embodiment 23′. The method of Embodiment 21′, wherein the base consists of ammonia.

Embodiment 24′. The method of any one of Embodiments 21′-23′, wherein the aqueous dispersion has a pH value of about 7.5 to about 11.

Embodiment 25′. The method of Embodiment 21′ or Embodiment 22′, wherein the base consists of ammonia; and/or the at least one ECA copolymer has an acid value of about 70 mg KOH/g copolymer to about 117 mg KOH/g copolymer, and the aqueous dispersion has a pH value of about 7.5 to about 10.

Embodiment 26′. The method of any one of Embodiments 18′-25′, wherein the glycol ether coupling solvent comprises at least one member selected from the group consisting of ethylene glycol monobutyl ether, ethylene glycol monoisobutyl ether, diethylene glycol monobutyl ether, ethylene glycol monoisopropyl ether, tripropylene glycol monomethyl ether, dipropylene glycol monomethyl ether, ethylene glycol monomethyl ether, propylene glycol monomethyl ether, ethylene glycol monomethyl ether, diethylene glycol monomethyl ether, and any combination thereof; and/or the glycol coupling solvent comprises hexylene glycol.

Embodiment 27′. The method of any one of Embodiments 18′-26′, wherein the coupling solvent comprises or consists of the glycol ether coupling solvent.

Embodiment 28′. The method of any one of Embodiments 18′-27′, wherein the at least one ECA copolymer has an acid value of about 70 mg KOH/g copolymer to about 117 mg KOH/g copolymer, and the aqueous dispersion has a pH value of about 7.5 to about 9.5.

Embodiment 29′. The method of Embodiment 28′, wherein the base comprises at least one member selected from the group consisting of ammonia, an amine, a metal-containing base, and any combination thereof.

Embodiment 30′. The method of Embodiment 29′, wherein the base comprises at least one amine selected from the group consisting of monocthanolamine (MEA), diethanolamine (DEA), triethanolamine (TEA), aminomethylpropanol (AMP), dimethylaminomethylpropanol (DMAMP), dimethylaminoethanol (DMAE), diethylaminoethanol (DEAE), dimethylaminopropanol (DMAP), and any combination thereof.

Embodiment 31′. The method of Embodiment 29′, wherein the base consists of ammonia.

Embodiment 32′. The method of any one of Embodiments 18′-31′, wherein a mass ratio of coupling solvent:ECA copolymer in the aqueous dispersion ranges from about 0.05 to about 0.7.

Embodiment 33′. The method of any one of Embodiments 18′-32′, wherein the particles have a D50 particle size of about 0.2 (micron) μm or less, as determined by laser diffraction.

Embodiment 34′. The method of any one of Embodiments 18′-33′, wherein the ECA copolymer comprises or consists of ethylene-acrylic acid (EAA).

Embodiment 35′. An aqueous dispersion comprising:
a continuous phase comprising an aqueous-based carrier fluid, and a coupling solvent;
a base; and
particles dispersed in the continuous phase and comprising at least one ethylene-carboxylic acid (ECA) copolymer comprising a plurality of carboxylic acid (CA) groups, and at least a portion of the CA groups are neutralized by at least a portion of the base;
   wherein the at least one ECA copolymer comprises ethylene-acrylic acid (EAA) and has an acid value of about 70 milligrams of KOH per gram copolymer (mg KOH/g copolymer) to about 125 mg KOH/g copolymer;
   wherein at least one of the following conditions is met:
Condition a) the coupling solvent comprises a glycol ether coupling solvent;
Condition b) the base consists of ammonia; and/or
Condition c) the at least one ECA copolymer has an acid value of about 70 mg KOH/g copolymer to about 117 mg KOH/g copolymer, and the aqueous dispersion has a pH value of about 7.5 to about 10.

To facilitate a better understanding of the aspects of the present disclosure, the following examples of preferred or representative aspects are given. In no way should the following examples be read to limit, or to define, the scope of the disclosure.

### EXAMPLES

In the examples below, viscosity was determined at room temperature using Brookfield LV-3 spindles at 60 RPM, solids content was determined using an Ohaus MB90 instrument at 150° C., D50 particle size was determined using a Malvern MASTERSIZER 3000 instrument, and MFI values were measured at 190° C. under a load of 2.16 kg in accordance with ASTM D1238.

Copolymer 1 is EAA containing 15 wt % acrylic acid with an acid value of 117 mg KOH/g and an MFI of 38 g/10 min @ 190° C. Copolymer 2 is EAA containing 11 wt % acrylic acid with an acid value of 86 mg KOH/g and an MFI of 8.5 g/10 min @ 190° C. Copolymer 3 is EAA with 9.5 wt % acrylic acid with an acid value of 74 mg KOH/g and an MFI of 20 g/10 min @ 190° C. Copolymer 4 is EMAA containing 15 wt % methacrylic acid with an acid value of 98 mg KOH/g and an MFI of 25 g/10 min @ 190° C. Copolymer 5 is EMAA containing 11 wt % methacrylic acid with an acid value of 72 mg KOH/g and an MFI of 60 g/10 min @ 190° C.

Example 1 (Comparative): 300.0 g Copolymer 1 was combined with 56.6 g aqueous ammonium hydroxide (19.0% NH₃) and 643.4 g softened water in a 2 L stainless steel Parr reactor. No other solvent was added. The mixture was heated at 115° C. and held for 4 h under 600 rpm agitation, following which an additional 500.0 g 95° C. softened water was added to the reactor under pressure to reduce the nominal total solids concentration to 20 wt %. The mixture was held for an additional 30 minutes at 115° C., following which agitation was reduced to 300 rpm and the mixture was cooled to room temperature. The mixture did not form a stable dispersion, and whole pellets remained intact.

Example 2 (Comparative): 400 g Copolymer 1 was combined with 66.9 g aqueous dimethylethanolamine (DMEA, 45.0%), and 477.5 g softened water in a 2 L stainless steel Parr reactor. The mixture was heated at 115° C. and held for 4 h under 600 rpm agitation, following which an additional 657.0 g 95° C. softened water was added to the reactor under pressure to reduce the nominal total solids concentration to 25 wt %. The mixture was held for an additional 30 minutes at 115° C., following which agitation was reduced to 300 rpm and the mixture was cooled to room temperature. There was significant build-up of resin on the reactor walls, undispersed and elongated resin beads, and the dispersion only had an experimentally measured solids content of 19.3 wt %. These observations indicate an incomplete dispersion of the resin.

Example 3 (Comparative): 400 g Copolymer 1 was combined with 49.4 g aqueous 2-dimethylamino-2-methyl-1-propanol (DMAMP, 80.0%), and 494.6 g softened water in a 2 L stainless steel Parr reactor. The mixture was heated at 115° C. and held for 4 h under 600 rpm agitation, following which an additional 656.0 g 95° C. softened water was added to the reactor under pressure to reduce the nominal total solids concentration to 25 wt %. The mixture was held for an additional 30 minutes at 115° C., following which agitation was reduced to 300 rpm and the mixture was cooled to room temperature. There was significant build-up of resin on the reactor walls, undispersed and elongated resin beads, and the dispersion only had an experimentally measured solids content of 12.0 wt %. These observations indicate an incomplete dispersion of the resin.

Example 4 (Inventive): 300.0 g Copolymer 1 was combined with 59.8 g aqueous ammonium hydroxide (18.0% NH₃), 42.85 g Eastman EB solvent (ethylene glycol monobutyl ether, EGMBE), and 597.4 g softened water in a 2 L stainless steel Parr reactor. The total concentration of EB solvent in the continuous phase at this stage was 6.2 wt %. The ratio of coupling solvent:Copolymer 1 was 0.143:1. The mixture was heated at 115° C. and held for 4 h under 600 rpm agitation, following which an additional 500.0 g 95° C. softened water was added to the reactor under pressure to reduce the total solids concentration to 20 wt %. The mixture was held for an additional 30 minutes at 115° C., following which agitation was reduced to 300 rpm and the mixture was cooled to room temperature. The final dispersion was transparent and had a pH of 9.84, a viscosity of 10⁵ centipoise (cP), an experimentally measured solids content of 19.6 wt %, and a D50 particle size of 0.0554 μm.

Example 5 (Inventive): 300.0 g Copolymer 1 was combined with 16.7 g aqueous ammonium hydroxide (18.9% NH₃), 137.4 g Eastman EB solvent, and 403.0 g softened water in a 2 L stainless steel Parr reactor. The total concentration of EB solvent in the continuous phase at this stage was 25.0 wt %. The ratio of coupling solvent:Copolymer 1 was 0.458:1. The mixture was heated at 115° C. and held for 2 h under 600 rpm agitation, following which an additional 506.5 g 95° C. softened water was added to the reactor under pressure to reduce the nominal total solids concentration to 22 wt %. The mixture was held for an additional 30 minutes at 115° C., following which agitation was reduced to 300 rpm and the mixture was cooled to room temperature. The final dispersion was transparent and had a pH of 7.96, a viscosity of 32 cP, an experimentally measured solids content of 22.2 wt %, and a D50 particle size of 0.084 μm.

Example 6 (Inventive): 350.0 g Copolymer 1 was combined with 9.0 g aqueous potassium hydroxide (45%), 156.3 g Eastman EB solvent, and 359.7 g softened water in a 2 L stainless steel Parr reactor. The total concentration of EB solvent in the continuous phase at this stage was 30.0 wt %. The ratio of coupling solvent:Copolymer 1 was 0.443:1. The mixture was heated at 115° C. and held for 2 h under 600 rpm agitation, following which an additional 486.8 g 95° C. softened water was added to the reactor under pressure to reduce the nominal total solids concentration to 26 wt %. The mixture was held for an additional 30 minutes at 115° C., following which agitation was reduced to 300 rpm and the mixture was cooled to room temperature. The final dispersion was opaque and had a pH of 7.55, a viscosity of 15.4 cP, an experimentally measured solids content of 26.5 wt %, and a D50 particle size of 0.0675 μm.

Example 7 (Inventive): 400 g Copolymer 1 was combined with 31.9 g aqueous ammonium hydroxide (19.0% NH₃), 59.4 g Eastman EB solvent, and 508.7 g softened water in a 2 L stainless steel Parr reactor. The total concentration of EB solvent in the continuous phase at this stage was 10.0 wt %. The ratio of coupling solvent:Copolymer 1 was 0.149:1. The mixture was heated at 115° C. and held for 4 h under 600 rpm agitation, following which an additional 600.0 g 95° C. softened water was added to the reactor under pressure to reduce the nominal total solids concentration to 25 wt %. The mixture was held for an additional 30 minutes at 115° C., following which agitation was reduced to 300 rpm and the mixture was cooled to room temperature. The final dispersion was translucent and had a pH of 8.80, a viscosity of 176 cP, an experimentally measured solids content of 23.8 wt %, and a D50 particle size of 0.0749 μm.

Example 8 (Inventive): 400 g Copolymer 1 was combined with 66.9 g aqueous DMEA (45.0%), 57.0 g Eastman EB solvent, and 476.2 g softened water in a 2 L stainless steel Parr reactor. The total concentration of EB solvent in the continuous phase at this stage was 10.0 wt %. The ratio of coupling solvent:Copolymer 1 was 0.143:1. The mixture was heated at 115° C. and held for 4 h under 600 rpm agitation, following which an additional 600 g 95° C. softened water was added to the reactor under pressure to reduce the nominal total solids concentration to 25 wt %. The mixture was held for an additional 30 minutes at 115° C., following which agitation was reduced to 300 rpm and the mixture was cooled to room temperature. The final dispersion was transparent and had a pH of 8.89, a viscosity of 533.9 cP, an experimentally measured solids content of 23.2 wt %, and a D50 particle size of 0.0585 μm.

Example 9 (Inventive): 350.0 g Copolymer 1 was combined with 18.4 g aqueous DMEA (45%), 164.7 g Eastman EB solvent, and 374.1 g softened water in a 2 L stainless steel Parr reactor. The total concentration of EB solvent in the continuous phase at this stage was 30.0 wt %. The ratio of coupling solvent:Copolymer 1 was 0.471:1. The mixture was heated at 115° C. and held for 2 h under 600 rpm agitation, following which an additional 642.9 g 95° C. softened water was added to the reactor under pressure to reduce the nominal total solids concentration to 20 wt %. The mixture was held for an additional 30 minutes at 115° C., following which agitation was reduced to 300 rpm and the mixture was cooled to room temperature. The final dispersion was opaque and had a pH of 7.9, a viscosity of 23.4 cP, an experimentally measured solids content of 20.1 wt %, and a D50 particle size of 0.0873 μm.

Example 10 (Inventive): 400 g Copolymer 1 was combined with 49.4 g aqueous DMAMP (80.0%), 56.1 g Eastman EB solvent, and 494.5 g softened water in a 2 L stainless steel Parr reactor. The total concentration of EB solvent in the continuous phase at this stage was 10.0 wt %. The ratio of coupling solvent:Copolymer 1 was 0.140:1. The mixture was heated at 115° C. and held for 4 h under 600 rpm agitation, following which an additional 600.0 g 95° C. softened water was added to the reactor under pressure to reduce the nominal total solids concentration to 25 wt %. The mixture was held for an additional 30 minutes at 115° C., following which agitation was reduced to 300 rpm and the mixture was cooled to room temperature. The final dispersion was transparent and had a pH of 8.98, a viscosity of 321.9 cP, an experimentally measured solids content of 23.7 wt %, and a D50 particle size of 0.0681 μm.

Example 11 (Inventive): 300 g Copolymer 1 was combined with 55.5 g aqueous ammonium hydroxide (19.0% NH₃), 86.2 g Eastman DB solvent (diethylene glycol monobutyl ether, DEGMBE), and 558.3 g softened water in a 2 L stainless steel Parr reactor. The total concentration of DB solvent in the continuous phase at this stage was 12.5 wt %. The ratio of coupling solvent:Copolymer 1 was 0.287:1. The mixture was heated at 115° C. and held for 4 h under 600 rpm agitation, following which an additional 500.0 g 95° C. softened water was added to the reactor under pressure to reduce the nominal total solids concentration to 20 wt %. The mixture was held for an additional 30 minutes at 115° C., following which agitation was reduced to 300 rpm and the mixture was cooled to room temperature. The final dispersion was transparent and had a pH of 9.62, a viscosity of 251.4 cP, an experimentally measured solids content of 20.5 wt %, and a D50 particle size of 0.0592 μm.

Example 12 (Inventive): 320 g Copolymer 1 was combined with 23.68 g aqueous ammonium hydroxide (19.0% NH₃), 101.3 g Eastman DB solvent, and 555.0 g softened water in a 2 L stainless steel Parr reactor. The total concentration of DB solvent in the continuous phase at this stage was 15.0 wt %. The ratio of coupling solvent:Copolymer 1 was 0.317:1. The mixture was heated at 115° C. and held for 2 h under 600 rpm agitation, following which an additional 280.0 g 95° C. softened water was added to the reactor under pressure to reduce the nominal total solids concentration to 25.0 wt %. The mixture was held for an additional 30 minutes at 115° C., following which agitation was reduced to 300 rpm and the mixture was cooled to room temperature. The final dispersion was transparent with a final pH of 8.40, a viscosity of 383.9 cP, an experimentally measured solids content of 25.3 wt %, and D50 particle size of 0.0651 μm.

Example 13 (Inventive): 300 g Copolymer 1 was combined with 57.0 g aqueous ammonium hydroxide (19.0% NH₃), 86.2 g tert-butanol, and 556.8 g softened water in a 2 L stainless steel Parr reactor. The total concentration of tert-butanol in the continuous phase at this stage was 12.5 wt %. The ratio of coupling solvent:Copolymer 1 was 0.287:1. The reactor was scaled and purged with nitrogen gas to remove the oxygen from the headspace. The mixture was heated at 115° C. and held for 2 h under 600 rpm agitation, following which an additional 500.0 g 95° C. softened water was added to the reactor under pressure to reduce the nominal total solids concentration to 20.0 wt %. The mixture was held for an additional 30 minutes at 115° C., following which agitation was reduced to 300 rpm and the mixture was cooled to room temperature. The final dispersion was transparent with a final pH of 9.9, a viscosity of 48.5 cP, an experimentally measured solids content of 18.9 wt %, and D50 particle size of 0.0575 μm.

Example 14 (Inventive): 280 g Copolymer 1 was combined with 53.2 g aqueous ammonium hydroxide (19.0% NH₃), 106.6 g isopropanol, and 461.3 g softened water in a 2 L stainless steel Parr reactor. The total concentration of isopropanol in the continuous phase at this stage was 15.0 wt %. The ratio of coupling solvent:Copolymer 1 was 0.381:1. The reactor was scaled and purged with nitrogen gas to remove the oxygen from the headspace. The mixture was heated at 115° C. and held for 2 h under 600 rpm agitation, following which an additional 342.9 g 95° C. softened water was added to the reactor under pressure to reduce the nominal total solids concentration to 20.0 wt %. The mixture was held for an additional 30 minutes at 115° C., following which agitation was reduced to 300 rpm and the mixture was cooled to room temperature. The final dispersion was transparent with a final pH of 9.8, a viscosity of 88 cP, an experimentally measured solids content of 20.0 wt %, and a D50 particle size of 0.0540 μm.

Example 15 (Inventive): 250 g Copolymer 1 was combined with 28.5 aqueous ammonia (19.0%), 127.5 g tert-butanol, and 486.8 g softened water in a 2 L stainless steel Parr reactor. The total concentration of tert-butanol in the continuous phase at this stage was 20.0 wt %. The ratio of coupling solvent:Copolymer 1 was 0.510:1. The reactor was sealed and purged with nitrogen gas to remove the oxygen from the headspace. The mixture was heated at 115° C. and held for 2 h under 600 rpm agitation, following which an additional 357.1 g 95° C. softened water was added to the reactor under pressure to reduce the nominal total solids concentration to 20 wt %. The mixture was held for an additional 30 minutes at 115° C., following which agitation was reduced to 300 rpm and the mixture was cooled to room temperature. The final dispersion was transparent with a final pH of 9.1, viscosity of 52.0 cP, an experimentally measured solids content of 20.0 wt %, and a D50 particle size of 0.0502 μm.

Example 16 (Inventive): 250 g Copolymer 1 was combined with 47.5 aqueous ammonia (19.0%), 95.1 g propylene glycol monomethyl ether (also known as 1-methoxy-2-propanol or PGME), and 500.3 g softened water in a 2 L stainless steel Parr reactor. The total concentration of PGME in the continuous phase at this stage was 15.0 wt %. The ratio of coupling solvent:Copolymer 1 was 0.380:1. The reactor was sealed and purged with nitrogen gas to remove the oxygen from the headspace. The mixture was heated at 115° C. and held for 2 h under 600 rpm agitation, following which an additional 357.1 g 95° C. softened water was added to the reactor under pressure to reduce the nominal total solids concentration to 20 wt %. The mixture was held for an additional 30 minutes at 115° C., following which agitation was reduced to 300 rpm and the mixture was cooled to room temperature. The final dispersion was transparent with a final pH of 9.8, viscosity of 315.9 cP, an experimentally measured solids content of 19.9 wt %, and D50 particle size of 0.0683 μm.

Example 17 (Comparative): 400 g Copolymer 2 was combined with 54.6 aqueous ammonia (19.0%), and 688.2 g softened water in a 2 L stainless steel Parr reactor. No EB solvent was added. The mixture was heated at 115° C. and held for 4 h under 600 rpm agitation, following which an additional 457.2 g 95° C. softened water was added to the reactor under pressure to reduce the total solids concentration to 25 wt %. The mixture was held for an additional 30 minutes at 115° C., following which agitation was reduced to 300 rpm and the mixture was cooled to room temperature. The mixture did not form a stable dispersion, and whole pellets remained intact.

Example 18 (Inventive): 350 g Copolymer 2 was combined with 47.8 g aqueous ammonia (19.0%), 80.2 g Eastman EB solvent, and 522.0 g softened water in a 2 L stainless steel Parr reactor. The total concentration of EB solvent in the continuous phase at this stage was 12.5 wt %. The ratio of coupling solvent:Copolymer 2 was 0.229:1. The mixture was heated at 115° C. and held for 4 h under 600 rpm agitation, following which an additional 400 g 95° C. softened water was added to the reactor under pressure to reduce the nominal total solids concentration to 25 wt %. The mixture was held for an additional 30 minutes at 115° C., following which agitation was reduced to 300 rpm and the mixture was cooled to room temperature. The solution remained viscous, so an additional 190.9 g softened water was added and stirred for 1 h, thereby reducing the solids concentration to 22 wt %. The final dispersion was translucent and had a pH of 9.88, a viscosity of 357.9 cP, an experimentally measured solids content of 20.7 wt %, and a D50 particle size of 0.0822 μm.

Example 19 (Inventive): 200.3 g Copolymer 2 was combined with 42.2 g aqueous ammonia (19.0%), 101.5 g tert-butanol, and 371.4 g softened water in a 2 L stainless steel Parr reactor. The total concentration of tert-butanol in the continuous phase at this stage was 20.0 wt %. The ratio of coupling solvent:Copolymer 2 was 0.507:1. The reactor was sealed and purged with nitrogen gas to remove the oxygen from the headspace. The mixture was heated at 115° C. and held for 2 h under 600 rpm agitation, following which an additional 286.1 g 95° C. softened water was added to the reactor under pressure to reduce the nominal total solids concentration to 25 wt %. The mixture was held for an additional 30 minutes at 115° C., following which agitation was reduced to 300 rpm and the mixture was cooled to room temperature. The final dispersion was transparent with a final pH of 10.1, a viscosity of 327.9 cP, an experimentally measured solids content of 19.5 wt %, and a D50 particle size of 0.0561 μm.

Example 20 (Inventive): 300 g Copolymer 2 was combined with 13.61 aqueous DMEA (45.0%), 8.6 g aqueous potassium hydroxide (45.0%), 111.3 g Eastman EB solvent, and 575.3 g softened water in a 2 L stainless steel Parr reactor. The total concentration of EB solvent in the continuous phase at this stage was 15.9 wt %. The ratio of coupling solvent:Copolymer 2 was 0.371:1. The reactor was sealed and purged with nitrogen gas to remove the oxygen from the headspace. The mixture was heated at 115° C. and held for 2 h under 600 rpm agitation, following which an additional 201.7 g 95° C. softened water was added to the reactor under pressure to reduce the nominal total solids concentration to 25 wt %. The mixture was held for an additional 30 minutes at 115° C., following which agitation was reduced to 300 rpm and the mixture was cooled to room temperature. The final dispersion was transparent with a final pH of 8.5, a viscosity of 279.9 cP, an experimentally measured solids content of 24.8 wt %, and a D50 particle size of 0.0640 μm.

Example 21 (Inventive): 300 g Copolymer 3 was combined with 38.53 g aqueous ammonium hydroxide (19.0% NH₃), 104.0 g Eastman DB solvent, and 557.5 g softened water in a 2 L stainless steel Parr reactor. The total concentration of DB solvent in the continuous phase at this stage was 15.0 wt %. The ratio of coupling solvent:Copolymer 3 was 0.347:1. The mixture was heated at 115° C. and held for 2 h under 600 rpm agitation, following which an additional 500 g 95° C. softened water was added to the reactor under pressure to reduce the nominal total solids concentration to 20.0 wt %. The mixture was held for an additional 30 minutes at 115° C., following which agitation was reduced to 300 rpm and the mixture was cooled to room temperature. The final dispersion was transparent with a final pH of 9.76, viscosity of 247.9 cP, an experimentally measured solids content of 20.3 wt %, and a D50 particle size of 0.0681 μm.

Example 22 (Inventive): 240 g Copolymer 3 was combined with 45.0 g aqueous ammonium hydroxide (19.0% NH₃), 121.8 g tert-butanol, and 450.3 g softened water in a 2 L stainless steel Parr reactor. The total concentration of tert-butanol in the continuous phase at this stage was 20.0 wt %. The ratio of coupling solvent:Copolymer 3 was 0.508:1. The reactor was scaled and purged with nitrogen gas to remove the oxygen from the headspace. The mixture was heated at 115° C. and held for 2 h under 600 rpm agitation, following which an additional 342.9 g 95° C. softened water was added to the reactor under pressure to reduce the nominal total solids concentration to 20.0 wt %. The mixture was held for an additional 30 minutes at 115° C., following which agitation was reduced to 300 rpm and the mixture was cooled to room temperature. The final dispersion was transparent with a final pH of 10.1, a viscosity of 513.9 cP, an experimentally measured solids content of 20.2 wt %, and a D50 particle size of 0.0574 μm.

Example 23 (Inventive): 330 g Copolymer 4 was combined with 51.5 g aqueous ammonium hydroxide (19.0% NH₃), 76.0 g Eastman EB solvent, and 642.5 g softened water in a 2 L stainless steel Parr reactor. The total concentration of EB solvent in the continuous phase at this stage was 10.0 wt %. The ratio of coupling solvent:Copolymer 4 was 0.230:1. The mixture was heated at 115° C. and held for 4 h under 600 rpm agitation, following which an additional 550.0 g 95° C. softened water was added to the reactor under pressure to reduce the nominal total solids concentration to 20 wt %. The mixture was held for an additional 30 minutes at 115° C., following which agitation was reduced to 300 rpm and the mixture was cooled to room temperature. The final dispersion was transparent and had a pH of 9.72, a viscosity of 124.0 cP, an experimentally measured solids content of 20.4 wt %, and a D50 particle size of 0.0793 μm.

Example 24 (Inventive): 240 g Copolymer 4 was combined with 57.3 aqueous ammonium hydroxide (19.0% NH₃), 121.4 g isopropanol, and 438.5 g softened water in a 2 L stainless steel Parr reactor. The total concentration of isopropanol in the continuous phase at this stage was 20.0 wt %. The ratio of coupling solvent:Copolymer 4 was 0.506:1. The reactor was scaled and purged with nitrogen gas to remove the oxygen from the headspace. The mixture was heated at 115° C. and held for 2 h under 600 rpm agitation, following which an additional 342.9 g 95° C. softened water was added to the reactor under pressure to reduce the nominal total solids concentration to 20 wt %. The mixture was held for an additional 30 minutes at 115° C., following which agitation was reduced to 300 rpm and the mixture was cooled to room temperature. The final dispersion was transparent with a final pH of 10.0, a viscosity of 96.0 cP, an experimentally measured solids content of 20.2 wt %, and a D50 particle size of 0.0516 μm.

Example 25 (Inventive): 300 g Copolymer 5 was combined with 35.89 g aqueous ammonium hydroxide (18.0% NH₃), 104.0 g Eastman EB solvent, and 560.1 g softened water in a 2 L stainless steel Parr reactor. The total concentration of EB solvent in the continuous phase at this stage was 15.0 wt %. The ratio of coupling solvent:Copolymer 5 was 0.347:1. The mixture was heated at 115° C. and held for 2 h under 600 rpm agitation, following which an additional 395.4 g 95° C. softened water was added to the reactor under pressure to reduce the nominal total solids concentration to 21.5 wt %. The mixture was held for an additional 30 minutes at 115° C., following which agitation was reduced to 300 rpm and the mixture was cooled to room temperature. The final dispersion was transparent with a final pH of 9.63, a viscosity of 34.0 cP, an experimentally measured solids content of 21.5 wt %, and a D50 particle size of 0.0593 μm.

Tables 1˜4 summarize the compositions and properties of the aqueous ECA copolymer dispersions obtained in Examples 1-25.

TABLE 1

| | Example Nos. | | | | | | | |
|---|---|---|---|---|---|---|---|---|
| | 1 | 2 | 3 | 4 | 5 | 6 | 7 | 8 |
| | Comp. | Comp. | Comp. | Inv. | Inv. | Inv. | Inv. | Inv. |
| wt % AA | 15 | 15 | 15 | 15 | 15 | 15 | 15 | 15 |
| Acid # | 117 | 117 | 117 | 117 | 117 | 117 | 117 | 117 |
| (mg KOH/g) | | | | | | | | |
| MFI @190° C. | 38 | 38 | 38 | 38 | 38 | 38 | 38 | 38 |
| (g/10 min) | | | | | | | | |
| Coupling | — | — | — | EGMBE | EGMBE | EGMBE | EGMBE | EGMBE |
| Solvent (CS) | | | | | | | | |
| CS:Polymer | — | — | — | 0.143:1 | 0.458:1 | 0.447:1 | 0.149:1 | 0.143:1 |
| (wt:wt) | | | | | | | | |
| Base | NH₃ | DMEA | DMAMP | NH₃ | NH₃ | KOH | NH₃ | DMEA |
| % CA | ~100 | ~40 | ~40 | ~100 | ~30 | ~10 | ~40 | ~40 |
| Neutralized | | | | | | | | |
| Stable | no | partial | partial | yes | yes | yes | yes | yes |
| Dispersion | | | | | | | | |
| Nominal wt % | 20 | 25 | 25 | 20 | 22 | 26 | 25 | 25 |
| Dispersed | | | | | | | | |
| Solids | | | | | | | | |
| Measured wt % | — | 19.3 | 12.0 | 19.6 | 22.2 | 26.5 | 23.8 | 23.2 |
| Dispersed | | | | | | | | |
| Solids | | | | | | | | |
| Particle Size | — | N/D | N/D | 0.0554 | 0.084 | 0.0675 | 0.0749 | 0.0585 |
| (D50, μm) | | | | | | | | |
| pH | — | N/D | N/D | 9.84 | 7.96 | 7.55 | 8.80 | 8.89 |
| Viscosity (cP) | — | N/D | N/A | 105 | 32 | 15.4 | 176 | 533.9 |

TABLE 2

| | Example Nos. | | | | | | | |
|---|---|---|---|---|---|---|---|---|
| | 9 | 10 | 11 | 12 | 13 | 14 | 15 | 16 |
| | Inv. | Inv. | Inv. | Inv. | Inv. | Inv. | Inv. | Inv. |
| wt % AA | 15 | 15 | 15 | 15 | 15 | 15 | 15 | 15 |
| Acid # (mg | 117 | 117 | 117 | 117 | 117 | 117 | 117 | 117 |
| KOH/g) | | | | | | | | |
| MFI @190° C. | 38 | 38 | 38 | 38 | 38 | 38 | 38 | 38 |
| (g/10 min) | | | | | | | | |
| Coupling | EGMBE | EGMBE | DEGMBE | DEGMBE | tBuOH | IPA | tBuOH | PGME |
| Solvent (CS) | | | | | | | | |
| CS:Polymer | 0.471:1 | 0.140:1 | 0.287:1 | 0.317:1 | 0.287:1 | 0.381:1 | 0.510:1 | 0.380:1 |
| (wt:wt) | | | | | | | | |
| Base | DMEA | DMAMP | NH₃ | NH₃ | NH₃ | NH₃ | NH₃ | NH₃ |
| % CA | ~15 | ~40 | ~100 | ~40 | ~100 | ~100 | ~65 | ~100 |
| Neutralized | | | | | | | | |
| Stable | yes | yes | yes | yes | yes | yes | yes | yes |
| Dispersion | | | | | | | | |
| Nominal wt % | 20 | 25 | 20 | 25 | 20 | 20 | 20 | 20 |
| Dispersed | | | | | | | | |
| Solids | | | | | | | | |
| Measured wt % | 20.1 | 23.7 | 20.5 | 25.3 | 18.9 | 20.0 | 20.0 | 19.9 |
| Dispersed | | | | | | | | |
| Solids | | | | | | | | |
| Particle Size | 0.0873 | 0.0681 | 0.0592 | 0.0651 | 0.0575 | 0.0540 | 0.0502 | 0.0683 |
| (D50, μm) | | | | | | | | |
| pH | 7.9 | 8.98 | 9.62 | 8.40 | 9.9 | 9.8 | 9.1 | 9.8 |
| Viscosity (cP) | 23.4 | 321.9 | 251.4 | 383.9 | 48.5 | 88 | 52.0 | 315.9 |

TABLE 3

| | Example Nos. | | | | | |
|---|---|---|---|---|---|---|
| | 17 | 18 | 19 | 20 | 21 | 22 |
| | Comp. | Inv. | Inv. | Inv. | Inv. | Inv. |
| wt % AA | 11 | 11 | 11 | 11 | 9.5 | 9.5 |
| Acid # (mg KOH/g) | 86 | 86 | 86 | 86 | 74 | 74 |
| MFI @190° C. (g/10 min) | 8.5 | 8.5 | 8.5 | 8.5 | 20 | 20 |
| Coupling Solvent (CS) | — | EGMBE | tBuOH | EGMBE | DEGMBE | tBuOH |
| CS:Polymer (wt:wt) | — | 0.229:1 | 0.507:1 | 0.371:1 | 0.347:1 | 0.508:1 |
| Base | NH₃ | NH₃ | NH₃ | DMEA/KOH | NH₃ | NH₃ |
| % CA Neutralized | ~100 | ~100 | ~150 | ~30 (15/15) | ~70 | ~170 |
| Stable Dispersion | no | yes | yes | yes | yes | yes |
| Nominal wt % | 25 | 22 | 20 | 25 | 20 | 20 |
| Dispersed Solids | | | | | | |
| Measured wt % | — | 20.7 | 19.5 | 24.8 | 20.3 | 20.2 |
| Dispersed Solids | | | | | | |
| Particle Size (D50, μm) | — | 0.0822 | 0.0561 | 0.0640 | 0.0681 | 0.0574 |
| pH | — | 9.88 | 10.1 | 8.5 | 9.76 | 10.1 |
| Viscosity (cP) | — | 357.9 | 327.9 | 279.9 | 247.9 | 513.9 |

TABLE 4

| | Example Nos. | | |
|---|---|---|---|
| | 23 | 24 | 25 |
| | Inv. | Inv. | Inv. |
| wt % MAA | 15 | 15 | 11 |
| Acid # (mg KOH/g) | 98 | 98 | 72 |
| MFI @190° C. (g/10 min) | 25 | 25 | 60 |
| Coupling Solvent (CS) | EGMBE | IPA | EGMBE |
| CS:Polymer (wt:wt) | 0.230:1 | 0.506:1 | 0.347:1 |
| Base | NH₃ | NH₃ | NH₃ |
| % CA Neutralized | ~100 | ~150 | ~100 |
| Stable Dispersion | yes | yes | yes |
| Nominal wt % Dispersed Solids | 20 | 20 | 21.5 |
| Measured wt % | 20.4 | 20.2 | 21.5 |
| Dispersed Solids | | | |
| Particle Size (D50, μm) | 0.0793 | 0.0516 | 0.0593 |
| pH | 9.72 | 10.0 | 9.63 |
| Viscosity (cP) | 124.0 | 96.0 | 34.0 |

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications may be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element, or group of elements is preceded with the transitional phrase “comprising,” it is understood that we also contemplate the same composition or group of elements with transitional phrases “consisting essentially of,” “consisting of,” “selected from the group consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

What is claimed is:

1. An aqueous dispersion comprising:
a continuous phase comprising an aqueous-based carrier fluid, a coupling solvent, and a base;
wherein at least a majority of the coupling solvent comprises a glycol coupling solvent, a glycol ether coupling solvent, or any combination thereof; and
particles dispersed in the continuous phase and comprising at least one ethylene-carboxylic acid (ECA) copolymer comprising a plurality of carboxylic acid (CA) groups, and at least a portion of the CA groups are neutralized by at least a portion of the base;
wherein the at least one ECA copolymer has an acid value of about 70 milligrams of KOH per gram copolymer (mg KOH/g copolymer) to about 125 mg KOH/g copolymer.

2. The aqueous dispersion of claim 1, wherein the at least one ECA copolymer is an ethylene-(meth)acrylic acid (E(M)AA) copolymer comprising methacrylic acid (MAA) and/or acrylic acid (AA) repeat units.

3. The aqueous dispersion of claim 1, wherein the at least one ECA copolymer has a melt flow index (MFI) of about 5 g/10 min to about 70 g/10 min at 190° C. under a 2.16 kg load.

4. The aqueous dispersion of claim 1, wherein the base comprises at least one member selected from the group consisting of ammonia, an amine, a metal-containing base, and any combination thereof.

5. The aqueous dispersion of claim 1, wherein the base consists of ammonia.

6. The aqueous dispersion of claim 1, wherein the glycol ether coupling solvent comprises at least one member selected from the group consisting of ethylene glycol monobutyl ether, ethylene glycol monoisobutyl ether, diethylene glycol monobutyl ether, ethylene glycol monoisopropyl ether, tripropylene glycol monomethyl ether, dipropylene glycol monomethyl ether, ethylene glycol monomethyl ether, propylene glycol monomethyl ether, ethylene glycol monomethyl ether, diethylene glycol monomethyl ether, and any combination thereof; and/or the glycol coupling solvent comprises hexylene glycol.

7. The aqueous dispersion of claim 1, wherein the coupling solvent comprises or consists of the glycol ether coupling solvent.

8. The aqueous dispersion of claim 1, wherein the at least one ECA copolymer has an acid value of about 70 mg KOH/g copolymer to about 117 mg KOH/g copolymer, and the aqueous dispersion has a pH value of about 7.5 to about 9.5.

9. The aqueous dispersion of claim 1, wherein a mass ratio of coupling solvent:ECA copolymer in the aqueous dispersion ranges from about 0.05 to about 0.7.

10. The aqueous dispersion of claim 1, wherein the particles have a D50 particle size of about 0.2 (micron) μm or less, as determined by laser diffraction.

11. The aqueous dispersion of claim 1, wherein the ECA copolymer comprises or consists of ethylene-acrylic acid (EAA).

12. A method for preparing an aqueous dispersion, comprising:
forming a mixture comprising:
a continuous phase comprising an aqueous-based carrier fluid, a coupling solvent, and a base;
wherein at least a majority of the coupling solvent comprises a glycol coupling solvent, a glycol ether coupling solvent, or any combination thereof; and
at least one ethylene-carboxylic acid (ECA) copolymer comprising a plurality of carboxylic acid (CA) groups, and at least a portion of the CA groups are neutralized by at least a portion of the base;
wherein the at least one ECA copolymer has an acid value of about 70 milligrams of KOH per gram copolymer (mg KOH/g copolymer) to about 125 mg KOH/g copolymer;
heating the mixture at an operation temperature of at least the melting point of the at least one ECA copolymer to form an aqueous emulsion comprising liquid droplets of the at least one ECA copolymer; and
cooling the aqueous emulsion to or below a temperature at which solid particles of the ECA copolymer form and produce an aqueous dispersion comprising the solid particles dispersed in the continuous phase.

13. The method of claim 12, wherein the at least one ECA copolymer is an ethylene-(meth)acrylic acid (E(M)AA) copolymer comprising methacrylic acid (MAA) and/or acrylic acid (AA) repeat units.

14. The method of claim 12, wherein the at least one ECA copolymer has a melt flow index (MFI) of about 5 g/10 min to about 70 g/10 min at 190° C. under a 2.16 kg load.

15. The method of claim 12, wherein the base comprises at least one member selected from the group consisting of ammonia, an amine, a metal-containing base, and any combination thereof.

16. The method of claim 12, wherein the base consists of ammonia.

17. The method of claim 12, wherein the glycol ether coupling solvent comprises at least one member selected from the group consisting of ethylene glycol monobutyl ether, ethylene glycol monoisobutyl ether, diethylene glycol monobutyl ether, ethylene glycol monoisopropyl ether, tripropylene glycol monomethyl ether, dipropylene glycol monomethyl ether, ethylene glycol monomethyl ether, propylene glycol monomethyl ether, ethylene glycol monomethyl ether, diethylene glycol monomethyl ether, and any combination thereof; and/or the glycol coupling solvent comprises hexylene glycol.

18. The method of claim 12, wherein the coupling solvent comprises or consists of the glycol ether coupling solvent.

19. The method of claim 12, wherein the at least one ECA copolymer has an acid value of about 70 mg KOH/g copolymer to about 117 mg KOH/g copolymer, and the aqueous dispersion has a pH value of about 7.5 to about 9.5.

20. The method of claim 12, wherein the ECA copolymer comprises or consists of ethylene-acrylic acid (EAA).
